(19) United States
(12) Patent Application Publication
(10) Pub. No.: US 2025/0361374 A1
(43) Pub. Date: Nov. 27, 2025

(54) HIGH STRENGTH AEROGEL MATERIAL AND METHOD

(71) Applicant: ASPEN AEROGELS, INC., Northborough, MA (US)

(72) Inventors: Joshua BARTELS, Northborough, MA (US); Nicholas LEVANTIS, Northborough, MA (US)

(21) Appl. No.: 19/108,110

(22) PCT Filed: Aug. 31, 2023
(86) PCT No.: PCT/US23/31717

§ 371 Date: Feb. 28, 2025

Related U.S. Application Data
(60) Provisional application No. 63/403,225, filed on Sep. 1, 2022.
(60) Provisional application No. 63/403,511, filed on Sep. 2, 2022.

(51) Int. Cl. C08J 9/28

(52) U.S. Cl. CPC C08J 9/28; C08J 2201/0502; C08J 2205/026; C08J 2379/08

(57) ABSTRACT

An aerogel with a polyimide matrix and associated methods are disclosed. In one example, the aerogel includes linear polyimide molecules with high molecular weight.

### CLAIM OF PRIORITY

This patent application claims the benefit of priority to U.S. Provisional Patent Application Ser. Nos. 63/403,511 entitled “HIGH STRENGTH AEROGEL MATERIAL AND METHOD,” filed on Sep. 2, 2022, and U.S. Provisional Patent Application Ser. Nos. 63/403,225 entitled “HIGH STRENGTH AEROGEL MATERIAL AND METHOD,” filed on Sep. 1, 2022, which are hereby incorporated by reference herein in their entireties.

### TECHNICAL FIELD

Embodiments described herein generally relate aerogel materials. Specific examples include polyimide aerogel materials with high compressive modulus, high plateau strength, and high toughness.

### BACKGROUND

Polyimide materials are useful in a number of engineering applications. For selected applications benefitting from light weight, high strength and low thermal conductivity properties, polymers such as polyimide can be formed into aerogel materials. However, aerogel materials can have lower mechanical property values than bulk materials. It is desirable to provide the benefits of aerogel micro/nanostructures with high levels of mechanical properties such as high Young's modulus, high compressive stress, etc.

### BRIEF DESCRIPTION OF THE DRAWINGS

FIG. 1 shows stress strain plots of polyimide materials in accordance with some example embodiments.

FIG. 2A shows a linear polymer molecule in accordance with some example embodiments.

FIG. 2B shows a branched polymer molecule in accordance with some example embodiments.

FIG. 2C shows a partially crystalline polymer molecule in accordance with some example embodiments.

FIG. 2D shows a crosslinked polymer molecule in accordance with some example embodiments.

FIG. 3A shows plots of mechanical properties of polyimide material formed by different methods in accordance with some example embodiments.

FIG. 3B shows normalized plots of mechanical properties of polyimide material formed by different methods in accordance with some example embodiments.

FIG. 4 shows a plot of mechanical properties of polyimide aerogel materials and other densities in accordance with some example embodiments.

FIG. 5 shows a plot of stoichiometric balance versus viscosity in accordance with some example embodiments.

FIG. 6 shows a plot of gel shrinkage versus viscosity in accordance with some example embodiments.

FIG. 7 shows a plot of molecular weight versus flexural stress for aerogel materials in accordance with some example embodiments.

FIG. 8 shows data of pyridine addition versus viscosity in accordance with some example embodiments.

FIG. 9 shows data of aerogel density versus flexural stress at breakage in accordance with some example embodiments.

FIG. 10 shows a flow diagram of a method of forming an aerogel in accordance with some example embodiments.

FIG. 11 shows images of A) SEM (50,000×) of carbon aerogel from low viscosity 2 wt % polyimide sol; B) SEM (50,100×) of carbon aerogel from high viscosity 2 wt % polyimide sol in accordance with some example embodiments.

FIG. 12 shows XRD scattering profile for polyimide aerogel in accordance with some example embodiments. Presence of many peaks confirms semi-crystalline structure of polyimide.

FIG. 13 shows a Houwink plot of intrinsic viscosity vs molecular weight for polyimide sols with DMAc solvent in accordance with some example embodiments. Linearity of the plot indicates primarily linear polymer with minimal or no branching.

FIG. 14 shows a plot of carbon aerogel compressive modulus vs. polyimide aerogel modulus in accordance with some example embodiments. The line drawn is a visual guide. Trend is the first known report of the modulus of the polymer aerogel influencing the modulus of the carbon aerogel. The novelty of the polyimide strength is thus reasonably expected to be observed in carbons derived from novel polyimides.

FIG. 15 shows a plot of Solid-state ¹³C NMR spectrum (upper left), solid-state ¹⁵N NMR spectrum (upper right), infrared spectrum (middle frame) and X-ray diffraction (lower frame) of a representative polyimide aerogel sample characterized in Tables in FIGS. 18 and 19.

FIG. 16A shows a plot of observed viscosity and GPC molecular weight. This confirms the change in viscosity originates from changes in molecular weight and not significantly affected by aggregation or other artifacts.

FIG. 16B shows a plot of logarithmic viscosity versus logarithmic molecular weight. The linearity of the plot extending to high molecular weight indicates linearity of the polymer, as branched materials show a diminished increase in intrinsic viscosity with increasing molecular weight.

FIG. 17 shows SEM images at two different magnifications (upper frames), Raman spectrum (middle frame), and X-ray diffraction (lower frame) of a representative carbon aerogel characterized in FIGS. 20 and 22.

FIG. 18 shows general material properties of polyimide aerogel samples.

FIG. 19 shows mechanical properties of polyimide aerogel samples.

FIG. 20 shows general material properties of carbon aerogel samples from polyimide aerogels as described.

FIG. 21 shows mechanical properties of polyimide aerogel samples prepared according to FIG. 23.

FIG. 22 shows mechanical properties of carbon aerogel samples from polyimide aerogels as described.

FIG. 23 shows sol formulations and viscosities for molecular weight controlled polyimides in DMAc.

### DESCRIPTION OF EMBODIMENTS

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

### Aerogels

Aerogels are solid materials that include a highly porous network of micro-, meso-, and macro-sized pores. Depending on precursor materials used and processing undertaken, the pores of an aerogel can frequently account for over 90% of the volume when the density of the aerogel is about 0.5 g/cc. Aerogels are generally prepared by removing the solvent from a gel (a solid network that contains a solvent) in a manner such that minimal or no contraction of the gel can be brought by capillary forces at its pore walls. Methods of solvent removal include, but are not limited to, supercritical drying (or drying using supercritical fluids, such that the low surface tension of the supercritical fluid exchanges with the transient solvent within the gel), exchange of solvent with supercritical fluid, exchange of solvent with fluid that is subsequently transformed to the supercritical state, sub-or near-critical drying, and sublimating a frozen solvent in a freeze-drying process. See for example, PCT Patent Application Publication No. WO2016127084A1. It should be noted that when drying in ambient conditions, gel contraction may take place with solvent evaporation, and a xerogel can form. Therefore, aerogel preparation through a sol-gel process or other polymerization processes typically proceeds in the following series of steps: dissolution of the solate in a solvent, addition of a catalyst, formation of a reaction mixture, formation of the gel (may involve additional heating or cooling), and solvent removal by a supercritical drying technique or any other method that removes solvent from the gel without causing contraction or pore collapse.

Aerogels can be formed of inorganic materials, organic materials. or mixtures thereof. When formed of organic materials such as, for example, phenols, resorcinol-formaldehyde (RF), phloroglucinol-furfuraldehyde (PF), polybenzoxazine (PBO), polyacrylonitrile (PAN), polyimide (PI), polyurethane (PU), polyurea (PUA), polyamide (PA), polybutadiene, polydicyclopentadiene, and precursors or polymeric derivatives thereof, the organic aerogel may be carbonized (e.g., by pyrolysis) to form a carbon aerogel, which can have properties (e.g., bulk density, skeletal density, porosity, pore volume, pore size distribution, morphology, etc.) that differ or overlap from each other, depending on the precursor materials and methodologies used.

With respect to the terms used in this disclosure, the following definitions are provided. This application will use the following terms as defined below unless the context of the text in which the term appears requires a different meaning.

The articles “a” and “an” are used herein to refer to one or to more than one (i.e., to at least one) of the grammatical object of the article. The term “about” used throughout this specification is used to describe and account for small fluctuations. For example, the term “about” can refer to less than or equal to ±10%, or less than or equal to ±5%, such as less than or equal to ±2%, less than or equal to ±1%, less than or equal to ±0.5%, less than or equal to ±0.2% less than or equal to ±0.1% or less than or equal to ±0.5%. All numeric values herein are modified by the term “about,” whether or not explicitly indicated. A value modified by the term “about” of course includes the specific value. For instance, “about 5.0” must include 5.0.

Within the context of the present disclosure, in some examples, the terms “framework” or “framework structure” refer to the network of nanoscopie and/or microscopic structural elements, such as fibrils, struts, and/or colloidal particles that form the solid structure of a gel or an aerogel. The structural elements that make up the framework structures have at least one characteristic dimension (e.g., length, width, diameter) of about 100 angstroms or less. In examples of pyrolyzed or carbonized aerogels, the terms “framework” or “framework structure” may refer to an interconnected network of linear fibrils, nanoparticles, a bicontinuous network (e.g., networks transitioning between a fibrillar and spherical morphology with aspects of both an transitional structures), or combinations thereof. In some examples, the linear fibrils, nanoparticles, or other structural elements may be connected together (at nodes in some examples) to form a framework that defines pores.

As used herein, the terms “aerogel,” and “aerogel material” refer to a solid object, irrespective of shape or size, comprising a framework of interconnected solid structures, with a corresponding network of interconnected pores integrated within the framework, and containing gases such as air as a dispersed interstitial mediom. As such, aerogels are open non-fluid colloidal or polymer networks that are expanded throughout their whole volume by a gas, and are formed by the removal of all swelling agents from a corresponding wet-gel without substantial volume reduction or network compaction. Aerogels are generally characterized by the following physical and structural properties (according to nitrogen porosimetry testing and helium pycnometry) attributable to aerogels: (a) an average pore diameter ranging from about 2 nm to about 100 not; (b) a porosity of at least 60% or more, and (c) a specific surface area of about 50 m²/g or more, such as from about 100 to about 1500 m²/g by nitrogen sorption analysis. It can be understood that the inclusion of additives, such as a reinforcement material or an electrochemically active species, for example, silicon, may decrease porosity and the specific surface area of the resulting aerogel composite. Densification may also decrease porosity of the resulting aerogel composite. Aerogel materials of the present disclosure include any aerogels which satisfy the defining elements set forth in the previous paragraph.

Aerogel materials of the present disclosure thus include any aerogels or other open-celled materials, which satisfy the defining elements set forth in previous paragraphs, including materials, which can be otherwise categorized as xerogels, cryogels, ambigels, microporous materials, and the like

As used herein, the term “xerogel” refers to a gel comprising an open, non-fluid colloidal or polymer networks that is formed by the removal of all swelling agents from a corresponding gel without any precautions taken to avoid substantial volume reduction or to retard compaction. Xerogels have surface areas of 0-700 m²/g as measured by nitrogen sorption analysis.

As used herein, the term “gelation” or “gel transition” refers to the formation of a wet gel from a polymer system. At a point in time, which is defined as the “gel point,” the sol loses fluidity. In the present context, gelation proceeds from an initial sol state, through a highly viscous disperse state, until the disperse state solidifies and the sol gels (the gel point), yielding a wet gel. The amount of time it takes for the reacting solution to transform into a gel in a form that can no longer flow is referred to as the “phenomenological gelation time.” Formally, gelation time is measured using rheology. Near the gel point, the elastic property of the solid gel starts dominating over the viscous properties of the fluid sol. The formal gelation time is near the time at which the real and imaginary components of the complex modulus of the gelling sol cross. The two moduli are monitored as a function of time using a rheometer. Time starts counting from the moment the last component of the sol is added to the solution. See, for example, discussions of gelation in H. H. Winter ′″Can the Gel Point of a Cross-linking Polymer Be Detected by the G′-G′″ Crossover?′″ Polym. Eng. Sci., 1987, 27, 1698-1702; S.-Y. Kim, D. O. Choi and S.-M. Yang ′″Rheological analysis of the gelation behavior of tetraethylorthosilane/vinyltriethoxysilane hybrid solutions′″ Korean J. Chem. Eng., 2002, 19, 190-196; and M. Muthukumar ′″Screening effect on viscoelasticity near the gel point′″ Macromolecules, 1989, 22, 4656-4658.

As used herein, the term ′″wet gel′″ refers to a gel in which the mobile interstitial phase within the network of interconnected pores is primarily comprised of a liquid phase such as a conventional solvent or water, liquefied gases such as liquid carbon dioxide, or a combination thereof. Aerogels typically require the initial production of a wet gel, followed by processing and extraction to replace the mobile interstitial liquid phase in the gel with air or another gas. Examples of wet gels include, but are not limited to: alcogels, hydrogels, ketogels, carbonogels, and any other wet gels known to those in the art.

Aerogels as disclosed herein have a density. As used herein, the term ′″density′″ refers to a measurement of the mass per unit volume of an aerogel material or composition. The term ′″density′″ generally refers to the troe or skeletal density of an aerogel material, as well as the bulk density of an aerogel composition. Density is typically reported as kg/m³ or g/cm³. The skeletal density of a polyimide or carbon aerogel may be determined by methods known in the art, including, but not limited to helium pycnometry. The bulk density of a polyimide or carbon aerogel may be determined by methods known in the art, including, but not limited to: Standard Test Method for Dimensions and Density of Preformed Block and Board-Type Thermal Insulation (ASTM C303, ASTM International, West Conshohocken, Pa.); Standard Test Methods for Thickness and Density of Blanket or Batt Thermal Insulations (ASTM C167, ASTM International, West Conshohocken, Pa.); or Determination of the apparent density of preformed pipe insulation (ISO 18098, International Organization for Standardization, Switzerland). Within the context of the present disclosure, density measurements are acquired according to ASTM C167 standards, unless otherwise stated. In some embodiments, the polyimide or carbon aerogels as disclosed herein have a bulk density from about 0.01 to about 0.3 g/cm³.

Aerogels as disclosed herein have a pore size distribution. As used herein, the term ′″pore size distribution′″ refers to the statistical distribution or relative amount of each pore size within a sample volume of a porous material. A narrower pore size distribution refers to a relatively large proportion of pores at a narrow range of pore sizes. In some embodiments, a narrow pore size distribution may be desirable in e.g., optimizing the amount of pores that can surround an electrochemically active species and maximizing use of the available pore volume. Conversely, a broader pore size distribution refers to relatively small proportion of pores at a narrow range of pore sizes. As such, pore size distribution is typically measured as a function of pore volume and recorded as a unit size of a full width at half max of a predominant peak in a pore size distribution chart. The pore size distribution of a porous material may be determined by methods known in the art, for example including, but not limited to, surface area, skeletal density, and porosimetry, from which pore size distribution can be calculated. Suitable methods for determination of such features include, but are not limited to, measurements of gas adsorption/desorption (e.g., nitrogen), helium pycnometry, mercury porosimetry, and the like. Measurements of pore size distribution reported herein are acquired by nitrogen sorption analysis unless otherwise stated. In certain embodiments, polyimide or carbon aerogels of the present disclosure have a relatively narrow pore size distribution.

Aerogel materials or compositions of the present disclosure can have a pore size at max peak from distribution of about 150 nm or less, 140 nm or less, 130 nm or less, 120 nm or less, 1 10 nm or less, 100 nm or less, 90 nm or less, 80 nm or less, 70 nm or less, 60 nm or less, 50 nm or less, 40 nm or less, 30 nm or less, 20 nm or less, 10 nm or less, 5 nm or less, 2 nm or less, or in a range between any two of these values.

Aerogels as disclosed herein have a pore volume. As used herein, the term ′″pore volume′″ refers to the total volume of pores within a sample of porous material. Pore volume is specifically measured as the volume of void space within the porous material, and is typically recorded as cubic centimeters por gram (cm³/g or cc/g). The pore volume of a porous material may be determined by methods known in the art, for example including, but not limited to, surface area and porosity analysis (e.g. nitrogen porosimetry, mercury porosimetry, helium pycnometry, and the like). In certain embodiments, polyimide or carbon aerogels of the present disclosure have a relatively large pore volume of about 1 cc/g or more, 1.5 cc/g or more, 2 cc/g or more, 2.5 cc/g or more, 3 cc/g or more, 3.5 cc/g or more, 4 cc/g or more, or in a range between any two of these values. In other embodiments, polyimide or carbon aerogels and xerogels of the present disclosure have a pore volume of about 0.03 cc/g or more, 0.1 cc/g or more, 0.3 cc/g or more, 0.6 cc/g or more, 0.9 cc/g or more, 1.2 cc/g or more, 1.5 cc/g or more, 1.8 cc/g or more, 2.1 cc/g or more, 2.4 cc/g or more, 2.7 cc/g or more, 3.0 cc/g or more, 3.3 cc/g or more, 3,6 cc/g or more, or in a range between any two of these values.

Generally, formation of an aerogel comprises drying the wet gel in one or more stages. In some embodiments, the wet gel (polyamic acid or polyimide) is aged. Following any aging, the resulting wet-gel material, may be collected (e.g., demolded) and washed or solvent exchanged in a suitable secondary solvent to replace the primary reaction solvent (i.e., water) present in the wet-gel. Such secondary solvents may be linear alcohols with 1 or more aliphatic carbon atoms, diols with 2 or more carbon atoms, or branched alcohols, cyclic alcohols, alicyclic alcohols, aromatic alcohols, polyols, ethers, ketones, cyclio ethers or their derivatives. In some embodiments, the secondary solvent is water, a C1 to C3 alcohol (e.g., methanol, ethanol, propanol, isopropanol), acetone, tetrahydrofuran, ethyl acetate, acetonitrile, supercritical fluid carbon dioxide (CO₂), or a combination thereof. In some embodiments, the secondary solvent is ethanol

Once the wet gel has been formed and processed, the liquid phase of the wet-gel (e.g. polyamic acid or polyimide) can then be at least partially extracted from the wet-gel material using extraction methods, including processing and extraction techniques, to form an aerogel material (i.e., ′″drying′″). Liquid phase extraction, among other factors, plays an important role in engineering the characteristics of aerogels, such as porosity and density, as well as related properties such as thermal conductivity. Generally, aerogels are obtained when a liquid phase is extracted from a wet gel in a manner that causes low shrinkage to the porous network and framework of the wet gel. Wet gels can be dried asing various techniques to provide aerogels or xerogels. In exemplary embodiments, wet-gel materials can be dried at ambient pressore, under vacuum (e.g., through freeze drying), at subcritical conditions, or at supercritical conditions to form the corresponding dry gel (e.g., an aerogel, such as a xerogel).

In some embodiment, it may be desirable to fine-tune the surface area of the dry gel. If fine-tuning of the surface area is desired, aerogels can be converted completely or partially to xerogels with various porosities. The high surface area of aerogels can be reduced by forcing some of the pores to collapse. This can be done, for example, by immersing the aerogels for a certain time in solvents such as ethanol or acetone or by exposing them to solvent vapor. The solvents are subsequently removed by drying at ambient pressure.

Aerogels are commonly formed by removing the liquid mobile phase from the wet-gel material at a temperature and pressure near or above the critical point of the liquid mobile phase Once the critical point is reached (near critical) or surpassed (supercritical, i.e., pressure and temperature of the system is at or higher than the critical pressure and critical temperature, respectively) a new supercritical phase appears in the fluid that is distinct from the liquid or vapor phase. The solvent can then be removed without introducing a liquid-vapor interface, capillary forces, or any associated mass transfer limitations typically associated with receding liquid-vapor boundaries. Additionally, the supercritical phase is more miscible with organic solvents in general, thus having the capacity for better extraction. Co-solvents and solvent exchanges are also commonly used to optimize the supercritical fluid drying process.

If evaporation or extraction occurs below the supercritical point, capillary forces generated by liquid evaporation can cause shrinkage and pore collapse within the gel material. Maintaining the mobile phase near or above the critical pressure and temperature during the solvent extraction process reduces the negative effects of such capillary forces. In certain embodiments of the present disclosure, the use of near-critical conditions just below the critical point of the solvent system may allow production of aerogels or compositions with sufficiently low shrinkage, thus producing a commercially viable end-product.

Wet gels can be dried using various techniques to provide aerogels. In example embodiments, wet-gel materials can be dried at ambient pressure, at subcritical conditions, or at supercritical conditions,

Both room temperature and high temperature processes can be used to dry gel materials at ambient pressure. In some embodiments, a slow ambient pressure drying process can be used in which the wet gel is exposed to air in an open container for a period of time sufficient to remove solvent, e.g., for a period of time in the range of hours to weeks, depending on the solvent, the quantity of wet-gel, the exposed surface area, the size of the wet gel, and the like.

In another embodiment, the wet-gel material is dried by heating. For example, the wet-gel material can be heated in a convection oven for a period of time to evaporate most of the solvent (e.g., ethanol). After partially drying, the gel can be left at ambient temperature to dry completely for a period of time, e.g., from hours to days. This method of drying produces xerogels.

In some embodiments, the wet-gel material is dried by freeze-drying. By ′″freeze drying′″ or ′″lyophilizing′″ is meant a low temperature process for removal of solvent that involves freezing a material (e.g., the wet-gel material), lowering the pressure, and then removing the frozen solvent by sublimation. As water represents an ideal solvent for removal by freeze drying, and water is the solvent in the method as disclosed herein, freeze drying is particularly suited for aerogel formation from the disclosed polyimide wet-gel materials. This method of drying produces cryogels, which may closely resemble aerogels.

Both supercritical and sub-critical drying can be used to dry wet-gel materials. In some embodiments, the wet-gel material is dried under subcritical or supercritical conditions. In an example embodiment of supercritical drying, the gel material can be placed into a high-pressure vessel for extraction of solvent with supercritical CO₂. After removal of the solvent. e.g., ethanol, the vessel can be held above the critical point of CO₂ for a period of time, e.g., about 30 minutes Following supercritical drying, the vessel is depressurized to atmospheric pressure. Generally, aerogels are obtained by this process.

In an example embodiment of subcritical drying, the gel material is dried using liquid CO₂ at a pressure in the range of about 800 psi to about 1200 psi at room temperature. This operation is quicker than supercritical drying; for example, the solvent (e.g., ethanol) can be extracted in about 15 minutes. Generally, aerogels are obtained by this process.

Several additional aerogel extraction techniques are known in the art, including a range of different approaches in the use of supercritical fluids in drying serogels, as well as ambient drying techniques. For example, Kistler (J. Phys Chem. (1932) 36: 52-64) describes a simple supercritical extraction process where the gel solvent is maintained above its critical pressure and temperature, thereby reducing evaporative capillary forces and maintaining the structural integrity of the gel network. U.S. Pat. No. 4,610,863 describes an extraction process where the gel solvent is exchanged with liquid carbon dioxide and subsequently extracted at conditions where carbon dioxide is in a supercritical state. U.S. Pat. No. 6,670,402 teaches extracting a liquid phase from a gel via rapid solvent exchange by injecting supercritical (rather than liquid) carbon dioxide into an extractor that has been pre-heated and pre-pressurized to substantially supercritical conditions or above, thereby producing aerogels. U.S. Pat. No. 5,962,539 describes a process for obtaining an aerogel from a polymeric material that is in the form of a sol-gel in an organic solvent, by exchanging the organic solvent for a fluid having a critical temperature below a temperature of polymer decomposition, and supercritically extracting the fluid from the sol-gel. U.S. Pat. No. 6,315,971 discloses a process for producing gel compositions comprising: drying a wet gel comprising gel solids and a drying agent to remove the drying agent under drying conditions sufficient to reduce shrinkage of the gel during drying. U.S. Pat. No. 5,420,168 describes a process whereby resorcinol/formaldehyde aerogels can be manufactured using a simple air-drying procedure. U.S. Pat. No. 5,565,142 describes drying techniques in which the gel surface is modified to be stronger and more hydrophobic, such that the gel framework and pores can resist collapse during ambient drying or subcritical extraction Other examples of extracting a liquid phase from aerogel materials can be found in U.S. Pat. Nos. 5,275,796 and 5,395,805.

In some embodiments, extracting the liquid phase from the wet gel uses supercritical conditions of carbon dioxide, including, for example: first substantially exchanging the primary solvent present in the pore network of the gel with liquid carbon dioxide; and then heating the wet gel (typically in an autoclave) beyond the critical temperature of carbon dioxide (about 31.06° C.) and increasing the pressure of the system to a pressure greater than the critical pressure of carbon dioxide (about 1070 psig). The pressure around the gel material can be slightly fluctuated to facilitate removal of the supercritical carbon dioxide fluid from the gel. Carbon dioxide can be recirculated through the extraction system to facilitate the continual removal of the primary solvent from the wet gel Finally, the temperature and pressure are slowly returned to ambient conditions to produce a dry aerogel material. Carbon dioxide can also be pre-processed into a supercritical state prior to being injected into an extraction chamber. In other embodiments, extraction can be performed using any suitable mechanism, for example altering the pressures, timings, and solvent discussed above.

For the convenience of illustration, the following section describes the composition, formation, and morphology of polyimide aerogels. It will be appreciated that many different precursors and techniques may be used to synthesize aerogels. Furthermore, it will be appreciated that processing parameters associated with these different aerogel compositions may be modified to accomplish a particular morphology.

Methods of forming a polyimide gel or aerogel, include those in which a polyimide gel is prepared in an organic solvent solution from condensation of a diamine and a tetracarboxylic acid dianhydride to form a polyamic acid, and dehydration of the polyamic acid. See, for example, U.S. Pat. Nos. 7,071,287 and 7,074,880 to Rhine et al., and U.S. Patent Application Publication No. 2020/0269207 to Zafiropoulos, et al.

Production of an aerogel, according to certain embodiments, includes the following steps: i) formation of a solution containing a gel precursor; ii) formation of a gel from the solution; and iii) extracting the solvent from the gel materials to obtain a dried aerogel material.

In one example, a polyimide aerogel is formed by combining at least one diamine and at least one dianhydride in a common polar aprotie solvent(s) Additional details regarding polyimide gel/aerogel formation can be found in U.S. Pat. Nos. 7,074,880 and 7,071,287 to Rhine et al.; U.S. Pat. No. 6,399,669 to Suzuki et al.; U.S. Pat. No. 9,745,198 to Leventis et al.; Leventis et al., Polyimide Aerogels by Ring-Opening Metathesis Polymerization (ROMP), Chem. Mater. 2011, 23, 8, 2250-2261, among others, each of which is incorporated herein by reference in its entirety.

In certain examples, the present disclosure involves the formation and use of nanoporous carbon-based scaffolds or structures, such as carbon aerogels, as electrode materials.

Furthermore, it is contemplated herein that the nanoporous carbon-based scaffolds or structures, and specifically carbon aerogels, can take the form of monolithic structures. When monolithic in nature, the carbon aerogel eliminates the need for any binders; in other words, the air cathode can be binder-less. As used herein, the term “monolithic” refers to aerogel materials in which a majority (by weight) of the aerogel included in the aerogel material or composition is in the form of a unitary, continuous, interconnected aerogel nanostructure. Monolithic aerogel materials include aerogel materials which are initially formed to have a unitary interconnected gel or aerogel nanostructure, but which can be subsequently cracked, fractured or segmented into non-unitary aerogel nanostructures.

Monolithic aerogel materials are differentiated from particulate aerogel materials. The term “particulate aerogel material” refers to aerogel materials in which a majority (by weight) of the aerogel included in the aerogel material is in the form of particulates, particles, granules, beads, or powders, which can be combined together (Le., via a binder, such as a polymer binder) or compressed together but which lack an interconnected aerogel nanostructure between individual particles. Collectively, aerogel materials of this form will be referred to as having a powder or particulate form (as opposed to a monolithic form). It should be noted that despite an individual particle of a powder having a unitary structure, the individual particle is not considered herein as a monolith. Integration of aerogel powder into an electrochemical cell typically involves preparation of a paste or slurry from the powder, casting and drying onto a substrate, and may optionally include calendaring.

Within the context of the present disclosure, the terms “binder-less” or “binder-free” (or derivatives thereof) refer to a material being substantially free of binders or adhesives to hold that material together. For example, a monolithic nanoporous carbon material is free of binder since its framework is formed as a unitary, continuous interconnected structure. Advantages of being binder-less include avoiding any effects of binders, such as on electrical conductivity and pore volume. On the other hand, aerogel particles require a binder to hold together to form a larger, functional material, such larger material is not contemplated herein to be a monolith. In addition, this “binder-free” terminology does not exclude all uses of binders. For example, a monolithic aerogel, according to the present disclosure, may be secured to another monolithic aerogel or a non-aerogel material by disposing a binder or adhesive onto a major surface of the aerogel material. In this way, the binder is used to create a laminate composite and provide electrical contact to a current collector, but the binder has no function to maintain the stability of the monolithic aerogel framework itself.

Nanoporous carbons, such as carbon aerogels, according to the present disclosure, can be formed from any suitable organic precursor materials. Examples of such materials include, but are not limited to, RF, PR, PI, polyamides, polyoxyalkylene, polyurethane, polyacrylonitrile, cresol formaldehyde, phenol-furfural, polyisocyanate, polyvinyl alcohol dialdehyde, polyisocyanurates,, various epoxide resins,, chitosan, and combinations and derivatives thereof. Any precursors of these materials may be used to create and use the resulting materials. In some examples, the carbon aerogel is formed from a pyrolyzed/carbonized polyimide-based aerogel, i.e., the polymerization of polyimide. Even more specifically, the polyimide-based aerogel can be produced using one or more methodologies described in U.S. Pat. Nos. 7,071,287 and 7,074,880 to Rhine et al., e.g., by imidization of poly (amic) acid and drying the resulting gel using a supercritical fluid. Other adequate methods of producing polyimide aerogels (and carbon aerogels derived therefrom) are contemplated heroin as well, for example as described in U.S. Pat. No. 6,399,669 to Suzuki et al.; U.S. Pat. No. 9,745,198 to Leventis et al.; Leventis et al.; Polyimide Aerogels by Ring-Opening Metathesis Polymerization (ROMP), Chem. Mater. 2011, 23, 8, 2250-2261; Leventis et al.; Isocyanate-Derived Organic Aerogels; Polyureas, Polyimides, Polyamides, MRS Proceedings, 1306 (2011), Mrsf10-1306-bb03-01. doi:10.1557/opl.2011.90; Chidambareswarapattar et al., One-step roon-temperature synthesis of fibrous polyimide aerogels from anhydrides and isocyanates and conversion to isomorphic carbons, J. Mater. Chem., 2010, 20, 9666-9678; Guo et al., Polyimide Aerogels Cross-Linked through Amine Functionalized Polyoligomeric Silsesquioxane, ACS Appl. Mater. Interfaces 2011, 3, 546-552; Nguyen et al., Development of High Temperature, Flexible Polyimide Aerogels, American Chemical Society, proceedings published 2011; Meador et al., Mechanically Strong, Flexible Polyimide Aerogels Cross-Linked with Aromatic Triamine, ACS Appl. Mater. Interfaces, 2012, 4 (2), pp 536-544; Meador et al., Polyimide Aerogels with Amide Cross-Links: A Low Cost Alternative for Mechanically Strong Polymer Aerogels, ACS Appl. Mater. Interfaces 2015, 7, 1240-1249; Pei et al., Preparation and Characterization of Highly Cross-Linked Polyimide Aerogels Based on Polyimide Containing Trimethoxysilane Side Groups, Langmuir 2014, 30, 13375-13383. The resulting polyimide aerogel would then be pyrolyzed to form a polyimide-derived carbon aerogel.

Carbon aerogels of the present disclosure may include those formed from any one or more of the following aerogels: polyimide-derived carbon aerogels; polybenzodiazine-derived carbon aerogels; polybenzoxazine-derived carbon aerogels; polyamide-derived carbon aerogels; polyimide-derived carbon aerogels wherein the polyimide aerogel is synthesized via the isocyanate route; polyacrylonitrile-derived carbon aerogels; polyurea-derived aerogels, phenolic-derived carbon aerogels; phenol-formaldehyde-derived carbon aerogels; pholoroglucinol-terephthalaldehyde-derived carbon aerogels; pholoroglucinol-formaldehyde-derived carbon aerogels.

In some examples, carbon aerogels of the present disclosure can have a residual nitrogen content of at least about 14 wt %. For example, carbon aerogels can have a residual nitrogen content of at least about 0.1 wt %, at least about 0.5 wt %, at least about 1 wta at least about 2 wt %, at least about 3 wt %, at least about 4 wt %, at least about 5 wt %, at least about 6 wt %, at least about 7 wt %, at least about 8 wt %, at least about 9 wt %, at least about 10 wt %, at least about 14 wt % or in a range between any two of these values.

In examples of the present disclosure, a dried polymeric aerogel composition can be subjected to a treatment temperature of 200° C. or above, 400° C. or above, 600° C. or above, 800° C. or above, 1000° C. or above, 1200° C. or above, 1400° C. or above, 1600° C. or above, 1800° C. or above, 2000° C. or above, 2200° C. or above, 2400° C. or above, 2600° C. or above, 2800° C. or above, or in a range between any two of these values, for carbonization of the organic (e.g., polyimide) aerogel. In exemplary embodiments, a dried polymeric aerogel composition can be subjected to a treatment temperature in the range of about 1000° C. to about 1100° C., e.g., at about 1050° C. Without being bound by theory, it is contemplated herein that the electrical conductivity of the aerogel composition increases with carbonization temperature. In some examples, some compositions or types of aerogels will become conductive when carbonized above a threshold carbonization temperature (e.g., above 400° C., above 500° C., above 600° C.)

Young's modulus may be determined by methods known in the art, for example including, but not limited to: Standard Test Practice for Instrumented Indentation Testing (ASTM E2546, ASTM International, West Conshocken, PA); or Standardized Nanoindentation (ISO 14577, International Organization for Standardization, Switzerland). Within the context of the present disclosure, measurements of Young's modulus are acquired according to ASTM E2546 and ISO 14577, unless otherwise stated. In certain embodiments, carbonized aerogel materials or compositions of the present disclosure have a Young's modulus of about 0.2 GPa or more, 0.4 GPa or more, 0.6 GPa or more, up to about 1 GPa, or in a range between any two of these values.

Within the context of the present disclosure, the term “strut width” refers to the average diameter of nanostruts, nanorods, nanofibers, or nanofilaments that form an aerogel having a fibrillar morphology. It can be recorded as any unit length, for example um or am. The strut width may be determined by methods known in the art, for example including, but not limited to, scanning electron microscopy image analysis. Within the context of the present disclosure, measurements of strut width are acquired according to this method, unless otherwise stated. Aerogel materials or compositions of the present disclosure can have a strut width of about 10 nm or less, 9 nm or less, 8 nm or less, 7 nm or less, 6 nm or less, 5 nm or less, 4 nm or less, 3 nm or less, 2 nm or less, or in a range between any two of these values. Smaller strut widthbe, such as those in the range of about 2-5 nm, permit a greater amount of struts to be present within the network and thus contact the electrochemically active species, in turn allowing more of the electrochemically active species to be present within the composite. This increases electrical conductivity and mechanical strength.

Within the context of the present disclosure, the term “fibrillar morphology” refers to the structural morphology of a nanoporous carbon (e.g., aerogel) being inclusive of struts, rods, fibers, or filaments. For example, choice of solvent, such as dimethylacetamide (DMAC), can affect the production of such morphology. Further, when the carbon aerogel is derived from polyimides, a crystalline polyimide results from the polyimide forming a linear polymer. Some examples of the present disclosure were observed surprisingly to include a fibrillar morphology as an interconnected polymeric structure, where a long linear structure was anticipated, based on the known behavior of the polyimide precursors. In comparison, the product form of the nanoporous carbon can alternatively be particulate in nature or powder wherein the fibrillar morphology of the carbon aerogel persists. In some examples, a fibrillar morphology can provide certain benefits over a particulate morphology, such as mechanical stability/strength and electrical conductivity, particularly when the nanoporous carbon is implemented in specific applications, for example as the anodic material in a LIB. It should be noted that this fibrillar morphology can be found in nanoporous carbons of both a monolithic form and a powder form; in other words, a monolithic carbon can have a fibrillar morphology, and aerogel powder/particles can have a fibrillar morphology. Furthermore, when the nanoporous carbon material contains additives, such as silicon or others, the fibrillar nanostructure inherent to the carbon material is preserved and serves as a bridge between additive particles.

As noted above, an aerogel material formed with a polyimide matrix can be formed in a number of different microstructures/nanostructures. Additionally, a number of different additional components and/or reinforcements may be added to modify a polyimide aerogel. In one example, polyimide aerogels disclosed include a BET surface area in a range from 400-730 m²/g. In one example, polyimide aerogels disclosed include porosity in a range from 80-96%. In one example, polyimide aerogels disclosed include an average pore diameter range from 8-30 nm.

### Example Embodiments and Experimental Results

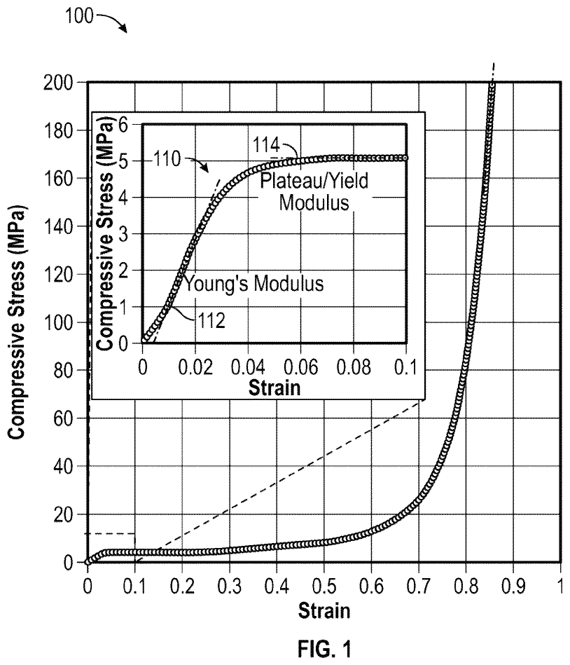

FIG. 1 shows a stress-strain curve 100 of an aerogel material according to one example. A close up view 110 of the stress-strain curve 100 shows a Young's modulus line 112 with a slope that is equal to the Young's Modulus for a measured polymer. A plateau modulus line 114 is also shown. Because the plateau modulus line 114 is approximately flat, a stress value (Y axis) of the plateau modulus line 114 indicates the plateau stress or yield stress of a measured polymer.

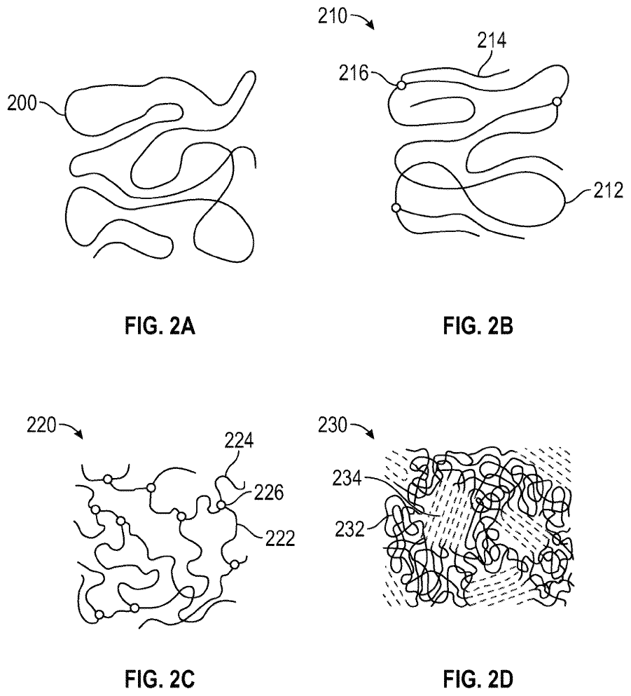

FIG. 2A shows an example of a linear polymer molecule 200. In one example, the linear polymer molecule 200 includes a polyimide molecule. FIG. 2A illustrates that a linear polymer molecule 200 includes a single polymer chain that does not branch or crosslink with other polymer molecules. As shown, the term “linear polymer molecule” does not require a polymer molecule to have a straight line conformation. An unbranched and uncrosslinked molecule 200 as shown in FIG. 2A likely will be twisted in a long randomly oriented conformation. In one example of a polyimide polymer described in the present disclosure, a length of the linear polymer molecule 200 and an amount of entanglement with other adjacent linear polymer molecules plays a large role in determining mechanical properties of a bulk polymer. In one example, a bulk polymer formed from linear polymer molecules as described is formed into a matrix of an aerogel configuration, where the matrix includes pores.

In contrast to the linear polymer molecule of FIG. 2A, FIG. 2B shows a branched polymer molecule 210. In one example a first polymer chain 212 branches into one or more sub-chains 214 at one or more branching locations 216. A complexity of a branched polymer molecule 210 provides a number of material properties that may be desirable, such as high modulus. However, a branched polymer molecule 210 may have negative properties such as decreased toughness. Branched polymers may also require additional cost and/or processing complexity to synthesize.

In contrast to the linear polymer molecule of FIG. 2A, FIG. 2C shows a crosslinked polymer molecule 220. In one example a first polymer chain 222 is chemically bonded to another polymer chain 224 at one or more crosslink sites 226. Similar to the branched polymer molecule example 210 from FIG. 2B, a complexity of a crosslinked polymer molecule 220 provides a number of material properties that may be desirable, such as high modulus.

FIG. 2D shows a partially crystalline polymer molecule 230. In one example, the partially crystalline polymer molecule 230 includes a polyimide molecule. In one example, the partially crystalline polymer molecule 230 includes a linear polymer molecule as described in FIG. 2A, without branching or crosslinking. A number of amorphous regions 232 are shown, and a number of crystalline regions 234 are shown. Variables, such as a number and size of the crystalline regions 234 affect mechanical properties of a bulk polymer. As noted above, a single linear polymer molecule with a sufficient molecular weight (related to length of polymer chain) may include both crystalline regions 234 and amorphous regions 232. A number of polymer molecules may also interact with each other and provide both crystalline regions 234 and amorphous regions 232. In a partially crystalline polymer, crystalline regions 234 may provide a pinning effect to movement of polymer molecules. This may provide desirable material properties such as high modulus and/or compressive strength without sacrificing toughness.

In one example, an amount of crystallinity is facilitated by high molecular weights of linear polyimide molecules as described in examples below. Branched and/or crosslinked molecules as described in FIGS. 2B and 2C may restrictor or prevent crystalline regions from forming. In one example, linear polyimide molecules of molecular weight greater than 10,000 g/mol provide sufficient crystalline regions to provide enhanced mechanical properties as described in examples below. In one example, linear polyimide molecules of molecular weight greater than 10,000 g/mol enhance mechanical properties through molecular entanglement.

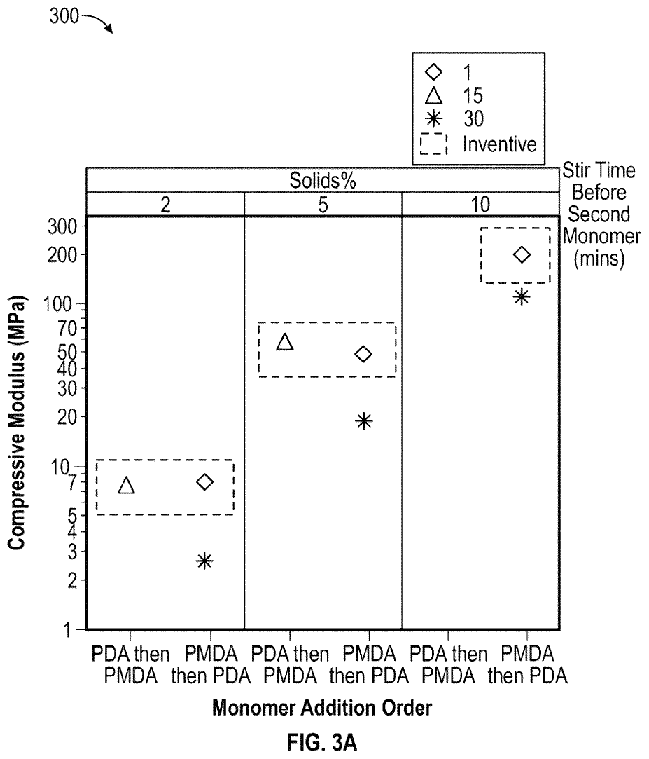

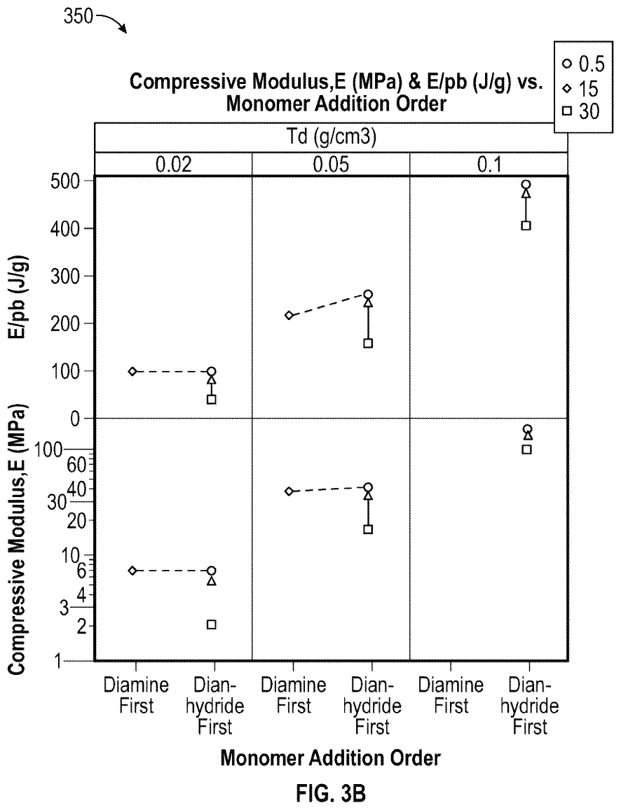

FIG. 3A shows a plot 300 of compressive modulus versus monomer addition order for a number of different polyimide aerogel samples synthesized at three different solution concentrations (2, 5, and 10% solids). The samples were formed by reacting pyromellitie dianbydride (PMDA) with p-phenylenediamine (PDA) to form polyamic acid molecules. The polyamic acid molecules were then chemically imidized by addition of pyridine and acetic anhydride to the polymer solution, resulting in a polyimide that retains the polyamic acid polymer chain length and branching extent. In one example, the polyimide molecules are linear polyimide molecules. FIG. 3A shows an effect of dissolving one or more components (PMDA, PDA) in dimethylacetamide (DMA_{c}). In one polymerization (stars) referred to as “slow normal”, PMDA is dissolved in DMA_{c} first and left stirring for 20-30 minutes. PDA is added later and left overnight to polymerize. Alternatively the PDA may be added after one minute of stirring the PMDA (diamonds) and is referred to as “fast normal” process. As shown in the plot, a slow normal process yields lower Young's modulus while the fast normal process results in increased Young's modulus.

By dissolving PDA in DMA_{c} first, then adding PMDA later, a reaction between the PMDA and PDA occurs preferentially over PMDA degradation. This process (PDA then PMDA) produces longer (higher molecular weight) linear polyimide molecules with improved mechanical properties over the “slow normal” process and comparable properties to the “fast normal” process. The PDA then PMDA method is not as sensitive to mixing time as high modulus can be achieved with 15 minute mixing time.

FIG. 3B shows a plot 350 that includes compressive modulus that has been normalized with respect to bulk density of aerogel. As indicated by the data of FIG. 3B, the improvements in mechanical properties, specifically compressive modulus are indicated from structural factors in the polyimide aerogel, and are not merely a result of altering aerogel density.

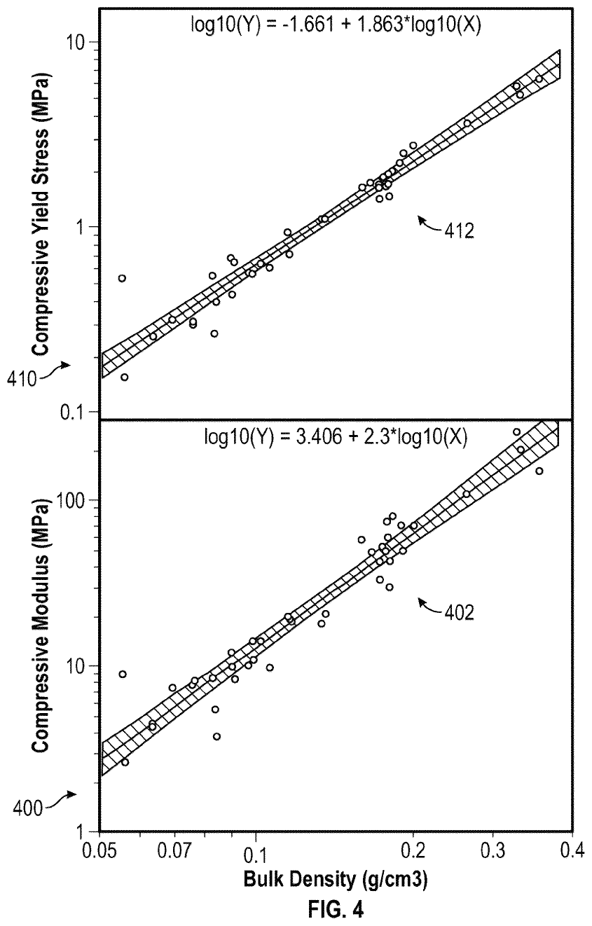

FIG. 4 shows a plot of compressive modulus 400 and compressive yield stress 410 versus aerogel bulk density for a number of different polyimide aerogel samples. Aerogel samples have been synthesized at solution concentrations between 2% and 10% solids. Young's modulus data 402 for bulk densities between 0.05 and 0.35 g/cm³ are shown. Properties of polyimide aerogel materials formed using methods described in the present disclosure show very high Young's modulus for the given density range. Compressive yield stress data 412 for bulk densities between 0.05 and 0.35 g/cm³ are shown. Polyimide aerogel materials with a polyimide matrix comprised of linear polyimide molecules exhibit a compressive yield stress up to 6.3 MPa for a bulk density between 0.05 and 0.35 g/cm³. Polyimide aerogel materials with a polyimide matrix comprised of linear polyimide molecules also exhibit a compressive modulus up to 254 MPa for a bulk density between 0.05 and 0.35 g/cm³.

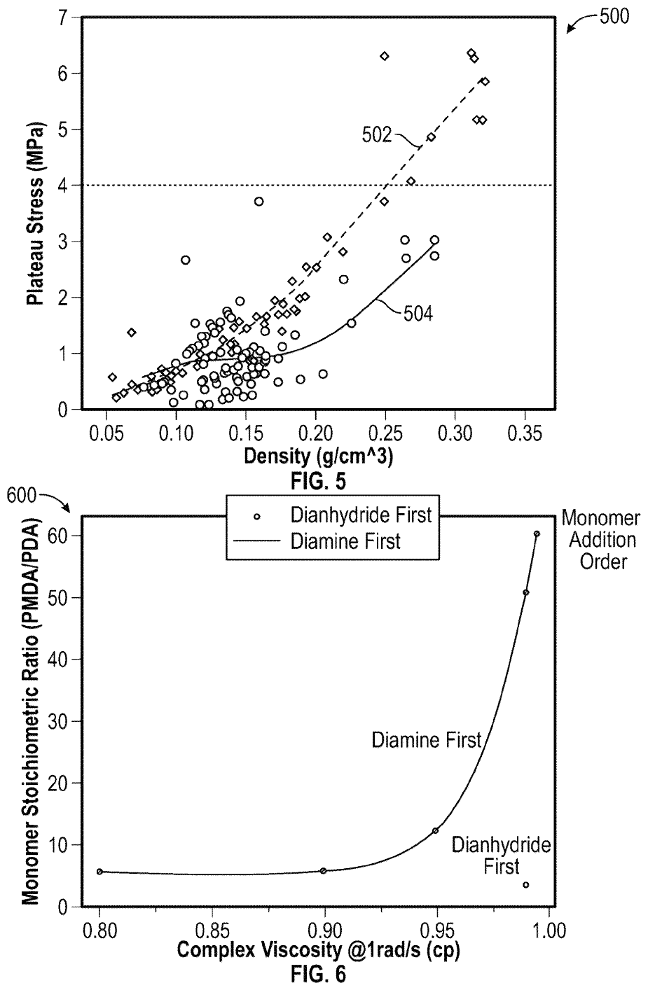

FIG. 5 shows a plot of plateao stress 500 with a number of samples, including present samples discussed and claimed in the present disclosure, and data from samples in current literature. As shown in FIG. 5, the present samples exhibit a trend 502 with improved plateau stress for a given bulk density over trend line 504 from current literature.

FIG. 6 shows a plot 600 of solution viscosity of 5% polyamic acid in DMA_{c} versus stoichiometrie balance (r=mols PMDA/mols PDA) between PMDA and PDA in accordance with some example embodiments. As r (x-axis) approaches 1.00, the reaction of PDMA approaches a complete 1 to 1reaction with PDA which results in higher degree of polymerization as described by the Carothers Equation. As indicated by the plot 600, viscosity of the polymerized gel increases as the stoichiometric balance approaches 1.00. As shown in FIG. 6, the “reverse” process of dissolving PDA in DMA_{c} first, then adding PMDA later yields a much higher viscosity. In one example, the higher viscosity can be attributed to higher molecular weight linear polymer formation.

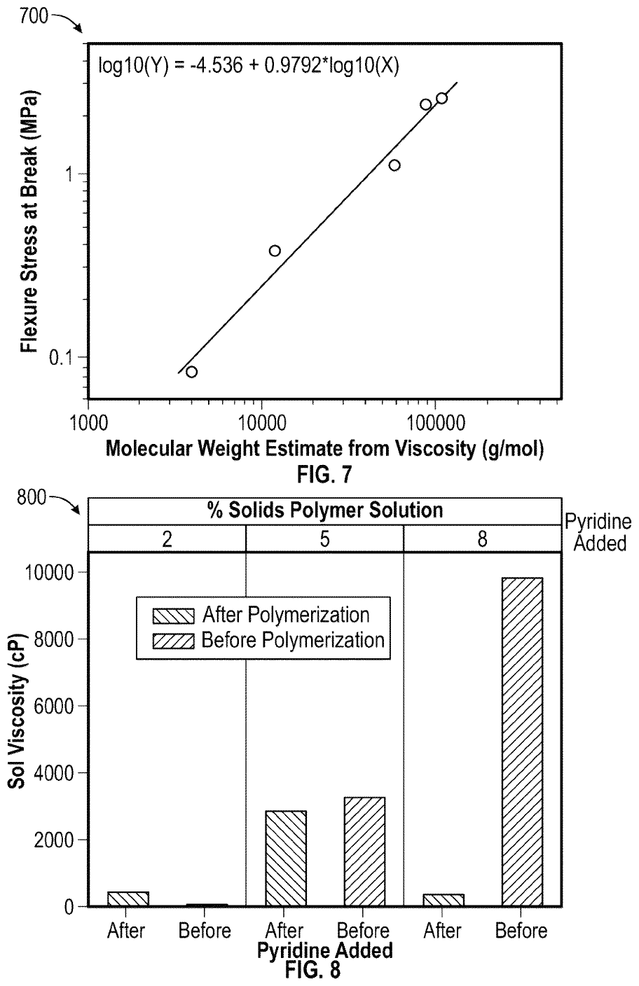

FIG. 7 shows a plot 700 of weight average molecular weight versus flexural stress for polyimide aerogel materials as described. The higher molecular weight samples are shown to provide higher flexural stress at break. In one example, higher viscosity gels indicate higher molecular weight linear molecules as discussed above. FIG. 7 directly relates molecular weight to one example mechanical property (flexural stress at break). Other mechanical properties such as compressive modulus and plateau stress are expected to follow a similar trend.

FIG. 8 shows data 800 of polyamic acid solution (sol) viscosity versus presence of pyridine before or after polymerization. Three polymer solution solids concentrations are shown. The Y-axis of the plots indicates viscosity of a resulting polymer solution, which as described above, relates to improved mechanical properties. In a process of forming a polyimide aerogel, addition of pyridine to PDA and DMA_{c} before adding PDMA improves the viscosity of the resulting gel. At high concentration pyridine significantly helps achieve higher molecular weight since it increases PDA solubility to allow for a better stoichiometric ratio of PDA/PMDA during polymerization. Low concentrations (below 5% solids) shows polymerization with pyridine results in lower viscosity, which leads to lower molecular weight.

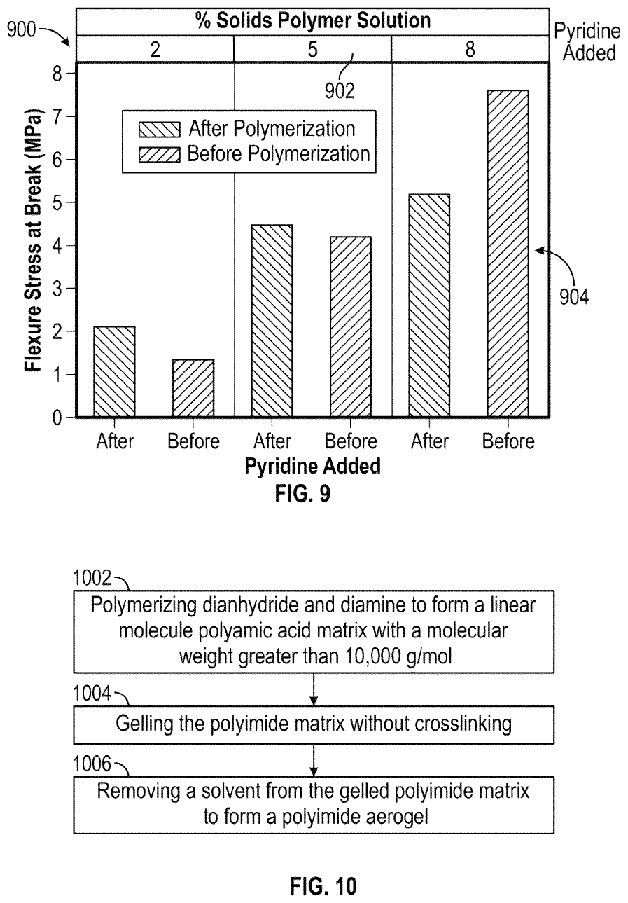

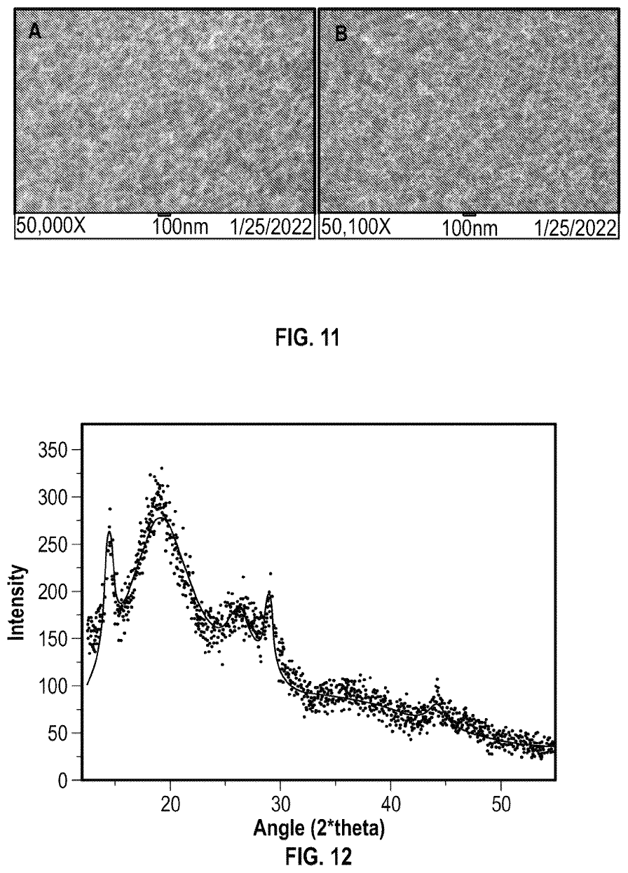

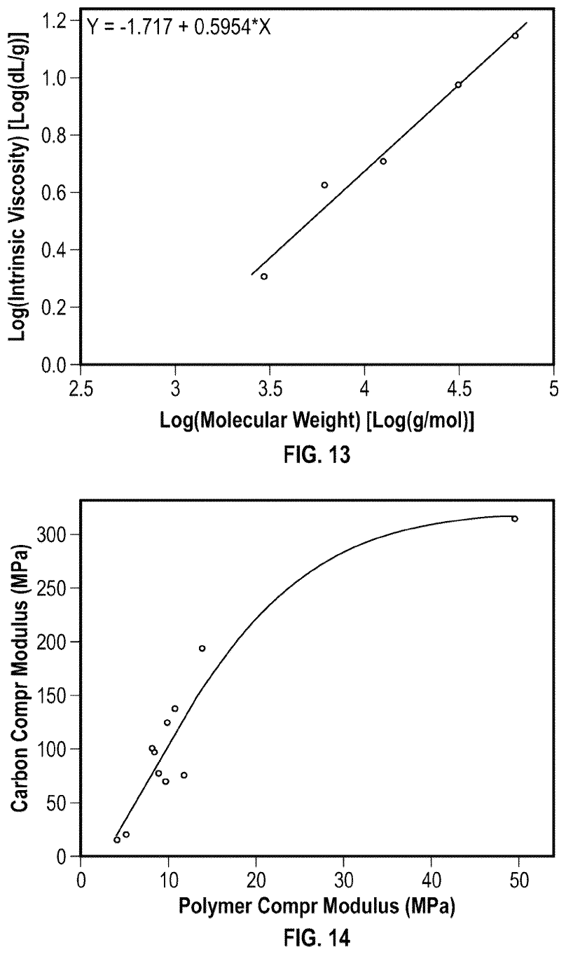

FIG. 9 shows data 900 of aerogel flexural stress at breakage vs pyridine addition timing. As shown in FIG. 8, above a middle point 902 of 5% solids polymer concentration, the addition of pyridine to the reaction before polymerization provides improved mechanical properties such as the plotted flexural stress at breakage. The improvement is shown at 904 on the plot 900. Below the middle point 902, the addition of pyridine lowers the flexural stress at breakage.

FIG. 10 shows an example flow diagram of a method of forming a polyimide aerogel. In operation 1002, PMDA and PDA are polymerized to form a polyamic acid matrix with a molecular weight greater than 10,000 g/mol. In operation 1004, the polyamic acid matrix is chemically imidized resulting in a gelled polyimide matrix without chemical crosslinking. In operation 1006 a solvent is removed from the gelled polyimide matrix to form a polyimide aerogel.

### General Synthesis Method

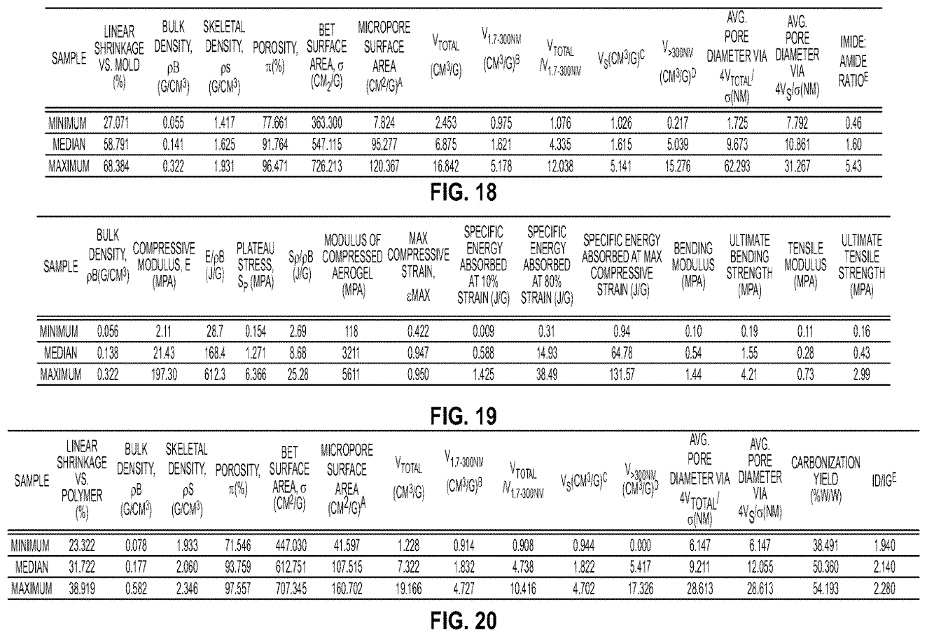

For illustration purposes, here describes the synthesis procedure for a representative polyimide sample from Tables in FIGS. 18 and 19. In that sample, T_{d} was set equal to 0.02, the pyridine to PMDA mol ratio was set equal to 1.0 and the acetic anhydride to PMDA ratio was set equal to 4.3. For this, 1,4-phenylenediamine (PDA; 18.23 g) was dissolved in 2667 mL of N,N-dimethylacetamide (DMAc) in a 4000 mL beaker. After 15 minutes, solid pyromellitic dianhydride (PMDA; 36.77 g) was added to the solution. The solution was stirred overnight at room temperature using a Caframo mechanical stirrer equipped with a 2-inch radius propeller shaft. At the end of the period 1.0 equivalent of pyridine (13.33 g, 13.57 mL) was added to the solution. After 2 minutes of mixing 4.3 equivalents of acetic anhydride (74.00 g, 68.52 ml.) was added to the solution. The target density, T_{d}, of the resulting sol was 0.02 g/cm³. The new solution was divided into cylindrical polypropylene syringe molds and was allowed to gel. The syringe molds were covered with 2 layers of Parafilm™ and were allowed to age for 24 hours at room temperature. In selected examples, a dianhydride is chosen from a list including, but not limited to, PMDA, BTDA, BPADA, BPDA, ODPA, DSDA, and 6FDA. In selected examples, a diamine is chosen from a list including, but not limited to, PDA, meta-PDA, ODA, BAPP, BDAF, DABP, DDM, DDS.

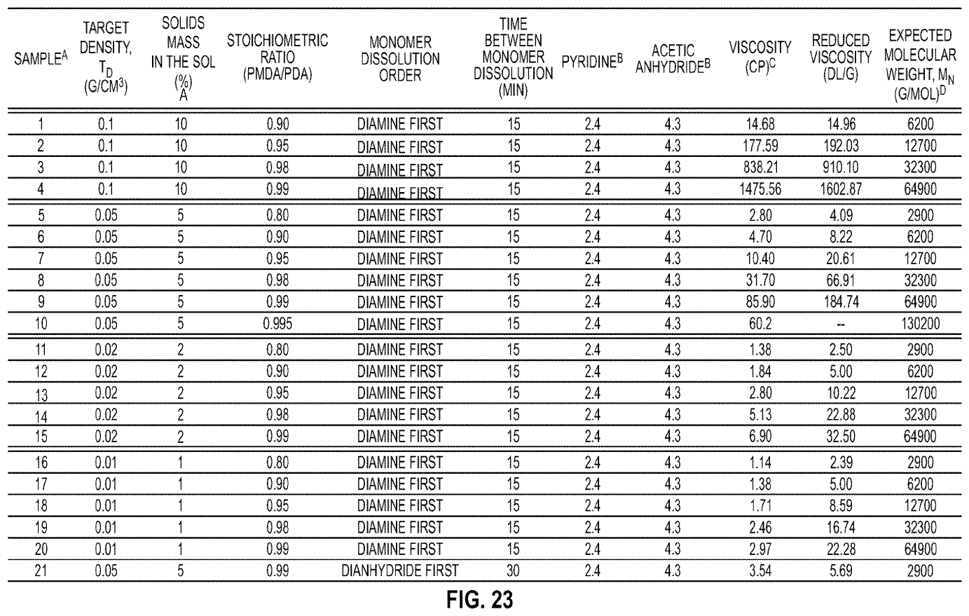

All remaining formulations were prepared following this procedure according to the following range of conditions. Target density, T_{d} from 0.02 g/cm³ to 0.10 g/cm³. Monomer stoichiometric balance PMDA/PDA molar ratio from 0.80 to 1.0. Monomer addition order either by dissolving the diamine fully first then adding the dianhydride, or by adding the dianhydride first followed by waiting either 30 s or 30 min then adding the diamine. Pyridine to PMDA molar ratio from 1 to 5 molar equivalents. Acetic anbydride to PMDA molar ratio from 0.75 to 4.3 molar equivalents. The table in FIG. 23 describes the formulations for a subset of samples that were designed with controlled molecular weights.

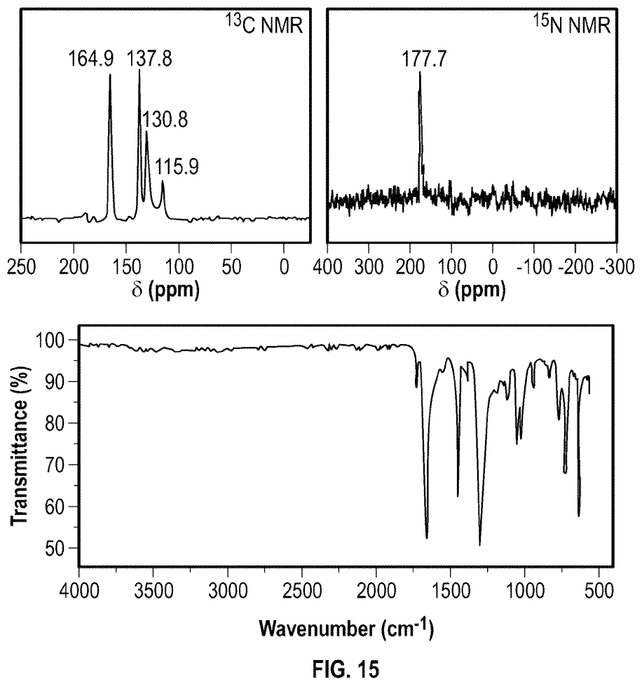

Here describes the processing procedure for a representative polyimide aerogel sample from Tables in FIGS. 18 and 19. After 24 hours following gelation, wet-gel samples were removed from the molds and were washed three times with ethanol at around 25° C., allowing for a 24 hour stay in fresh ethanol per wash. Some other wet-gel samples were removed from the molds and were washed three times with ethanol in a hermetically closed container placed in an oven at 68° C., allowing for a 24 hour stay in fresh ethanol at 68° C. per wash. The resulting wet gels from either process were dried with supercritical fluid (SCF) carbon dioxide to produce polyimide aerogel monoliths. The aerogel monoliths were then stored at ambient conditions. Select aerogel samples were thermally treated at 300° C. in air for 4 hr to complete conversion of any remaining polyamic acid groups to polyimide. For the general material properties of these aerogels refer to FIG. 18. For their mechanical properties refer to FIG. 19 and FIG. 21. FIG. 15 shows the solid-state ¹³C NMR, ¹⁵N NMR, infrared (IR) and X-ray diffraction (XRD) spectra of a representative polymer aerogel sample.

NMR (top) and FTIR (middle) confirm the chemical structure of the polyimide. Nitrogen NMR (top-right) indicates the extent of conversion from polyamide to polyimide, a single peak around 178 ppm confirms complete monomer conversion to polyimide. Sharp peaks in XRD (bottom) indicate crystallinity. Integration analysis is done to obtain % crystallinity. We have studied effects of amount of crystallinity: extent of crystallinity does not correspond to mechanical strength, however, all strong samples we have measured do have nonzero crystallinity.

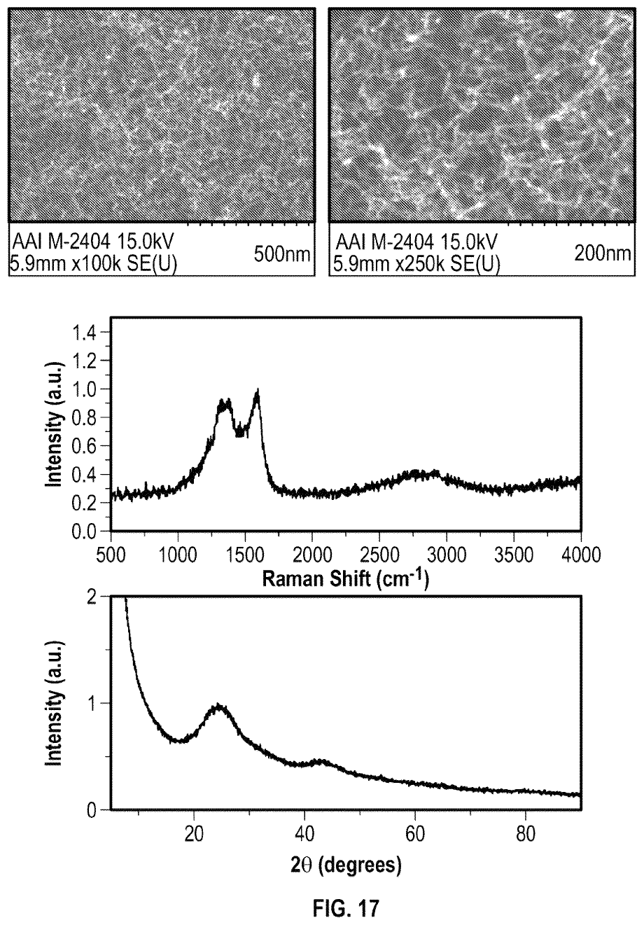

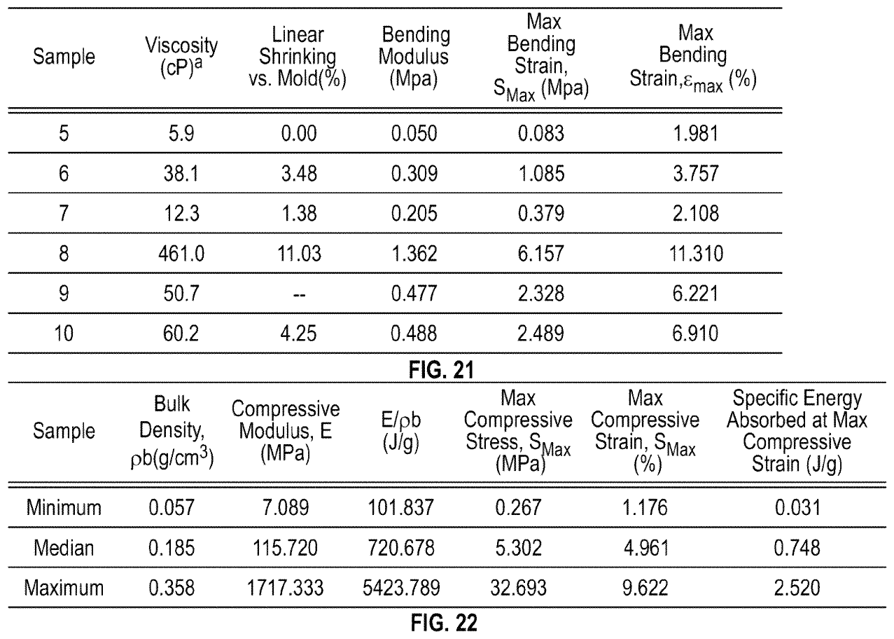

Finally, aerogel monoliths from all previous wash and thermal processes were heated at 5° C./min up to 1050° C. and were held at that temperature for 2 hours under flowing nitrogen (10 SCFH) yielding the corresponding carbon aerogel monoliths. For the general material properties of these aerogela refer to FIG. 20. For their mechanical properties refer to FIG. 22. FIG. 17 shows SEM images at two different magnifications, as well as the XRD and Raman spectra of a representative carbon aerogel sample.

### Molecular Weight Determination

Polymer molecular weight (MW) was measured in two ways:

1. GPC

Polyamic acid samples synthesized in DMF were diluted with DMF to 10 mg/mL, then run in a Tohsoh EcoSEC Elite GPC at 0.5 mL/min at 40° C. Peak elution time and a calibration curve from a polystyrene standard were used to define molecular weight.

2. Rheology

Polyamic acid samples were synthesized in DMAc with various target molecular weights via controlled monomer stoichiometry (PMDA/PDA) and at different concentrations. The linear viscoelastic response of the polyamic acid solutions was measured at 25° C. by rheology via a cone (60 mm diameter 2° slope) and plate geometry on a temperature-controlled Peltier plate. Continuous flow rheology was performed on polymer solutions at 1 rad/s to determine viscosity. A log-linear plot of reduced viscosity vs polymer concentration linearly extrapolates to the zero-concentration viscosity which defines the intrinsic viscosity of each molecular weight controlled sample. A Mark-Houwink plot is constructed by plotting intrinsic viscosity vs. polymer molecular weight, where the molecular weight is derived from the Carothers equation. The Mark-Houwink parameter a was calculated to be 0.60, a reasonable value for a polymer in a good solvent.

Comparing expected MW from the Carother's equation to experimental GPC molecular weight results shows a highly linear relationship where the GPC result is lower than the ideal expectation by a factor of 0.57. The discrepancy arises from an incomplete extent of reaction.

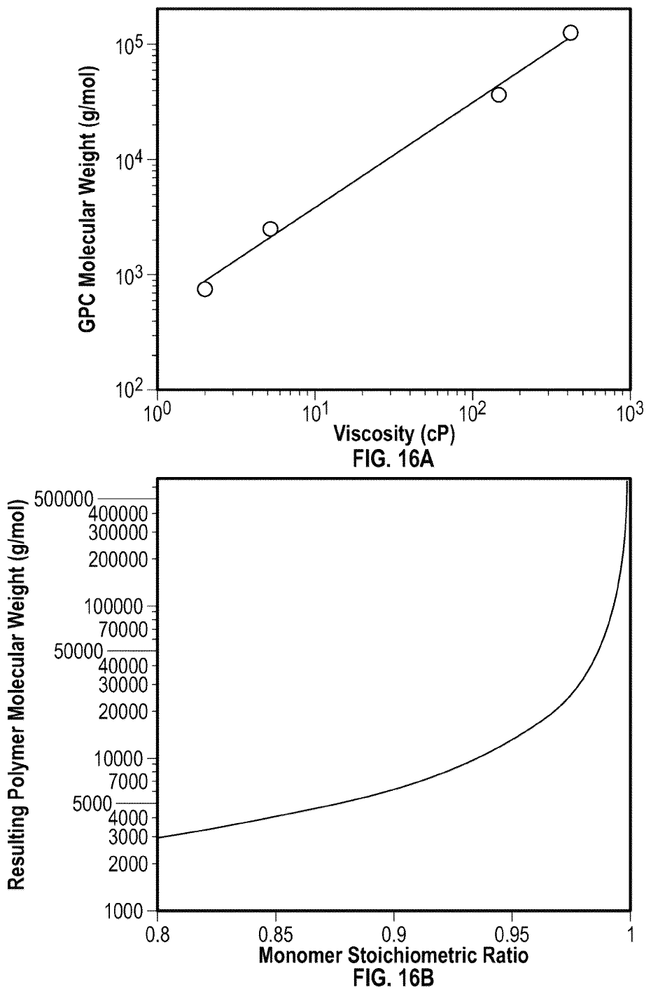

High stoichiometrie control of reagents results in controlled polymer molecular weight as polymer chain length is predicted by the Carothers equation 1:

$${x}_{n} = \frac{1 + r}{1 + r - 2 rp} \to \frac{1 + r}{1 - r}$$

Where xₙ is the degree of polymerization, r is the stoichiometric ratio between A and B monomers, and p is the extent of reaction which is assumed to approach unity for sufficiently long reaction times. Using this equation, we predict the resulting polymer number average molecular weight (Mn) from an intentional imbalance in monomer stoichiometry as shown in FIG. 16C.

### SAMPLE PREPARATION

Sample 1. Polyamic acid solution prepared at a total solids (PDA+PMDA) concentration in solvent=0.10 g/cm³, using a PMDA-to-PDA mol ratio of 0.90 (Refer to FIG. 23). 1,4-Phenylenediamine (PDA; 3,552 g) was dissolved in 100 ml of N.N-dimethylacetamide (DMAc) in a 500 ml beaker. After 15 minutes, solid pyromellitie dianhydride (PMDA; 6.448 g) was added to the solution (0.9 mol/mol PMDA/PDA). The solution was stirred overnight at room temperature using a magnetic stir bar. At the end of the period the viscosity was measured using a rheometer.

Sample 2. Polyamic acid solution prepared at a total solids (PDA+PMDA) concentration in solvent=0.10 g/cm³, using a PMDA-to-PDA mol ratio of 0.95 (Refer to FIG. 23). 1,4-Phenylenediamine (PDA: 3.429 g) was dissolved in 100 mL of N,N-dimethylacetamide (DMAc) in a 500 mL beaker. After 15 minutes, solid pyromellitie dianhydride (PMDA; 6.571 g) was added to the solution (0.95 mol/mol PMDA/PDA). The solution was stirred overnight at room temperature using a magnetic stir bar. At the end of the period the viscosity was measured using a rheometer.

Sample 3. Polyamic acid solution prepared at a total solids (PDA+PMDA) concentration in solvent=0.10 g/cm³, using a PMDA-to-PDA mol ratio of 0.98 (Refer to FIG. 23). 1,4-Phenylenediamine (PDA, 3.359 g) was dissolved in 100 mL of N.N-dimethylacetamide (DMAc) in a 500 mL beaker After 15 minutes, solid pyromellitie dianhydride (PMDA; 6.641 g) was added to the solution (0.98 mol/mol PMDA/PDA). The solution was stirred overnight at room temperature using a magnetic stir bar. At the end of the period the viscosity was measured using a rheometer.

Sample 4, Polyamic acid solution prepared at a total solids (PDA+PMDA) concentration in solvent=0.10 g/cm³, using a PMDA-to-PDA mol ratio of 0.99 (Refer to FIG. 23). 1,4-Phenylenediamine (PDA; 3.337 g) was dissolved in 100 mL of N,N-dimethylacetamide (DMAc) in a 500 ml beaker. After 15 minutes, solid pyromellitic dianhydride (PMDA; 6.663 g) was added to the solution (0.99 mol/mol PMDA/PDA). The solution was stirred overnight at room temperature using a magnetic stir bar. At the end of the period the viscosity was measured using a rheometer.

Sample 5. Polyamic acid solution and polyimide aerogels prepared at a total solids (PDA+PMDA) concentration in solvent=0.050 g/cm³, using a PMDA-to-PDA mol ratio of 0.80 (Refer to FIG. 23). 1,4-Phenylenediamine (PDA: 3.826 g) was dissolved in 200 mL of N,N-dimethylacetamide (DMAc) in a 500 mL beaker. After 15 minutes, solid pyromellitic dianhydride (PMDA; 6.174 g) was added to the solution (0.80 mol/mol PMDA/PDA). The solution was stirred overnight at room temperature using a magnetic stir bar. At the end of the period the viscosity was measured using a rheometer.

Another solution of polyamic acid was prepared similarly, and the viscosity was recorded (FIG. 21), Then, 2.4 equivalent of pyridine (5.82 g, 5.93 mL) was added to the solution. After 2 minutes of mixing 4.3 equivalents of acetic anhydride (13.46 g, 12.46 mL) was added to the solution. The target density, T_{d}, of the resulting sol was 0.046 g/cm³. The new solution was divided into shallow circular aluminum casting dishes and was allowed to gel. The casting dishes were covered and were allowed to age for 24 hours. Subsequently. wet gels were removed from the molds and were washed three times with ethanol at around 25° C., allowing for a 24 hour stay in fresh ethanol per wash. The resulting wet gels were dried with supercritical fluid (SCF) carbon dioxide to thin polyimide aerogel monoliths, which were stored at ambient conditions. These aerogels were also subjected to a three-point bending test (results in FIG. 21).

Sample 6. Polyamic acid solution and polyimide aerogels prepared at a total solids (PDA+PMDA) concentration in solvent=0.050 g/cm³, using a PMDA-to-PDA mol ratio of 0.90 (Refer to FIG. 23) 1,4-Phenylenediamine (PDA; 3.552 g) was dissolved in 200 mL of N,N-dimethylacetamide (DMAc) in a 500 ml beaker. After 15 minutes, solid pyromellitic dianhydride (PMDA; 6.448 g) was added to the solution (0.90 mol/mol PMDA/PDA). The solution was stirred overnight at room temperature using a magnetic stir bar. At the end of the period the viscosity was measured using a rheometer.

Another solution of polyamic acid was prepared similarly, and the viscosity was recorded (FIG. 21). Then, 2.4 equivalent of pyridine (5.82 g, 5.93 mL) was added to the solution. After 2 minutes of mixing 4.3 equivalents of acetic anhydride (13.46 g, 12.46 mL) was added to the solution. The target density, T_{d}, of the resulting sol was 0.046 g/cm³. The new solution was divided into shallow circular aluminum casting dishes and was allowed to gel. The casting dishes were covered and were allowed to age for 24 hours. Subsequently, wet gels were removed from the molds and were washed three times with ethanol at around 25° C., allowing for a 24 hour stay in fresh ethanol per wash. The resulting wet gels were dried with supercritical fluid (SCF) carbon dioxide to thin polyimide aerogel monoliths, which were stored at ambient conditions. These aerogels were also subjected to a three-point bending test (results in FIG. 21)

Sample 7. Polyamic acid solution and polyimide aerogels prepared at a total solids (PDA+PMDA) concentration in solvent=0.050 g/cm³, using a PMDA-to-PDA mol ratio of 0.95 (Refer to FIG. 23). 1,4-Phenylenediamine (PDA; 3.429 g) was dissolved in 200 mL of N,N-dimethylacetamide (DMAc) in a 500 ml beaker. After 15 minutes, solid pyromellitie dianhydride (PMDA; 6.571 g) was added to the solution (0.95 mol/mol PMDA/PDA) The solution was stirred overnight at room temperature using a magnetic stir bar. At the end of the period the viscosity was measured using a rheometer.

Another solution of polyamic acid was prepared similarly, and the viscosity was recorded (FIG. 21). Then, 2.4 equivalent of pyridine (5.82 g, 5.93 mL) was added to the solution. After 2 minutes of mixing 4.3 equivalents of acetic anhydride (13.46 g, 12.46 mL) was added to the solution. The target density, T_{d}, of the resulting sol was 0.046 g/cm³. The new solution was divided into shallow circular aluminum casting dishes and was allowed to gel. The casting dishes were covered and were allowed to age for 24 hours. Subsequently, wet gels were removed from the molds and were washed three times with ethanol at around 25° C., allowing for a 24 hour stay in fresh ethanol per wash. The resulting wet gels were dried with supercritical fluid (SCF) carbon dioxide to thin polyimide aerogel monoliths, which were stored at ambient conditions. These aerogels were also subjected to a three-point bending test (results in FIG. 21).

Sample 8. Polyamic acid solution and polyimide aerogels prepared at a total solids (PDA+PMDA) concentration in solvent=0.050 g/cm³, using a PMDA-to-PDA mol ratio of 0.98 (Refer to FIG. 23). 1,4-Phenylenediamine (PDA; 3.359 g) was dissolved in 200 ml of N,N-dimethylacetamide (DMAc) in a 500 mL beaker. After 15 minutes, solid pyromellitic dianhydride (PMDA; 6.641 g) was added to the solution (0.98 mol/mol PMDA/PDA). The solution was stirred overnight at room temperature using a magnetic stir bar. At the end of the period the viscosity was measured using a rheometer.

Another solution of polyamic acid was prepared similarly, and the viscosity was recorded (FIG. 21). Then, 2.4 equivalent of pyridine (5.82 g, 5.93 mL) was added to the solution. After 2 minutes of mixing 4.3 equivalents of acetic anhydride (13.46 g, 12.46 mL) was added to the solution. The target density, T^{d}, of the resulting sol was 0.046 g/cm³. The new solution was divided into shallow circular aluminum casting dishes and was allowed to gel. The casting dishes were covered and were allowed to age for 24 hours. Subsequently, wet gels were removed from the molds and were washed three times with ethanol at around 25° C., allowing for a 24 hour stay in fresh ethanol per wash. The resulting wet gels were dried with supercritical fluid (SCF) carbon dioxide to thin polyimide aerogel monoliths, which were stored at ambient conditions. These aerogels were also subjected to a three-point bending test (results in FIG. 21)

Sample 9. Polyamic acid solution and polyimide aerogels prepared at a total solids (PDA+PMDA) concentration in solvent=0.050 g/cm³, using a PMDA-to-PDA mol ratio of 0.99 (Refer to FIG. 23). 1,4-Phenylenediamine (PDA; 3.337 g) was dissolved in 200 mL of N,N-dimethylacetamide (DMAc) in a 500 ml beaker. After 15 minutes, solid pyromellitic dianhydride (PMDA: 6.663 g) was added to the solution (0.99 mol/mol PMDA/PDA). The solution was stirred overnight at room temperature using a magnetic stir bar. At the end of the period the viscosity was measured using a rheometer.

Another solution of polyamic acid was prepared similarly, and the viscosity was recorded (FIG. 21). Then, 2.4 equivalent of pyridine (5.82 g, 5.93 mL) was added to the solution. After 2 minutes of mixing 4.3 equivalents of acetic anhydride (13.46 g, 12.46 miL) was added to the solution. The target density, T_{d}, of the resulting sol was 0.046 g/cm³. The new solution was divided into shallow circular aluminum casting dishes and was allowed to gel. The casting dishes were covered and were allowed to age for 24 hours. Subsequently, wet gels were removed from the molds and were washed three times with ethanol at around 25° C., allowing for a 24 hour stay in fresh ethanol per wash. The resulting wet gels were dried with supercritical fluid (SCF) carbon dioxide to thin polyimide aerogel monoliths, which were stored at ambient conditions. These aerogels were also subjected to a three-point bending test (results in FIG. 21).

Sample 10. Polyamic acid solution and polyimide aerogels prepared at a total solids (PDA+PMDA) concentration in solvent=0.050 g/cm³, using a PMDA-to-PDA mol ratio of 0.995 (Refer to FIG. 23). 1,4-Phenylenediamine (PDA: 3.337 g) was dissolved in 200 mL of N,N-dimethylacetamide (DMAc) in a 500 ml beaker. After 15 minutes, solid pyromellitic dianbydride (PMDA; 6.674 g) was added to the solution (0.995 mol/mol PMDA/PDA). The solution was stirred overnight at room temperature using a magnetic stir bar. At the end of the period the viscosity was measured using a rheometer.

Another solution of polyamic acid was prepared similarly, and the viscosity was recorded (FIG. 21). Then, 2.4 equivalent of pyridine (5.82 g, 5.93 ml.) was added to the solution. After 2 minutes of mixing 4.3 equivalents of acetic anhydride (13.46 g. 12.46 mL.) was added to the solution. The target density, T_{d}, of the resulting sol was 0.046 g/cm³. The new solution was divided into shallow circular aluminum casting dishes and was allowed to gel. The casting dishes were covered and were allowed to age for 24 hours. Subsequently. wet gels were removed from the molds and were washed three times with ethanol at around 25° C., allowing for a 24 hour stay in fresh ethanol per wash. The resulting wet gels were dried with supercritical fluid (SCF) carbon dioxide to thin polyimide aerogel monoliths, which were stored at ambient conditions. These aerogels were also subjected to a three-point bending test (results in FIG. 21).

Sample 11. Polyamic acid solution prepared at a total solids (PDA+PMDA) concentration in solvent=0 020 g/cm³, using a PMDA-to-PDA mol ratio of 0.80 (Refer to FIG. 23). 1,4-Phenylenediamine (PDA; 3.826 g) was dissolved in 500 mL of N.N-dimethylacetamide (DMAc) in a 1000 ml beaker. After 15 minutes, solid pyromellitic dianhydride (PMDA; 6.174 g) was added to the solution (0.80 mol/mol PMDA/PDA). The solution was stirred overnight at room temperature using a magnetic stir bar. At the end of the period the viscosity was measured using a rheometer.

Sample 12. Polyamic acid solution prepared at a total solids (PDA+PMDA) concentration in solvent=0.020 g/cm³, using a PMDA-to-PDA mol ratio of 0.90 (Refer to FIG. 23). 1,4-Phenylenediamine (PDA; 3.552 g) was dissolved in 500 mL of N.N-dimethylacetamide (DMAc) in a 1000 ml beaker. After 15 minutes, solid pyromellitio dianhydride (PMDA: 6.448 g) was added to the solution (0,90 mol/mol PMDA/PDA). The solution was stirred overnight at room temperature using a magnetic stir bar. At the end of the period the viscosity was measured using a rheometer.

Sample 13. Polyamic acid solution prepared at a total solids (PDA+PMDA) concentration in solvent=0.020 g/cm³, using a PMDA-to-PDA mol ratio of 0.95 (Refer to FIG. 23). 1,4-Phenylenediamine (PDA; 3,429 g) was dissolved in 500 mL of N.N-dimethylacetamide (DMAc) in a 1000 ml beaker. After 15 minutes, solid pyromellitie dianhydride (PMDA, 6.571 g) was added to the solution (0.95 mol/mol PMDA/PDA). The solution was stirred overnight at room temperature using a magnetic stir bar. At the end of the period the viscosity was measured using a rheometer,

Sample 14. Polyamic acid solution prepared at a total solids (PDA+PMDA) concentration in solvent=0.020 g/cm³, using a PMDA-to-PDA mol ratio of 0.98 (Refer to FIG. 23). 1,4-Phenylenediamine (PDA; 3.359 g) was dissolved in 500 mL of N,N-dimethylacetamide (DMAc) in a 1000 mL beaker. After 15 minutes, solid pyromellitic dianhydride (PMDA; 6.641 g) was added to the solution (0.98 mol/mol PMDA/PDA). The solution was stirred overnight at room temperature using a magnetic stir bar. At the end of the period the viscosity was measured using a rheometer.

Sample 15. Polyamic acid solution and polyimide aerogels prepared at a total solids (PDA+PMDA) concentration in solvent=0.020 g/cm³, using a PMDA-to-PDA mol ratio of 0.99 (Refer to FIG. 23). 1,4-Phenylenediamine (PDA; 3.337 g) was dissolved in 500 mL of N,N-dimethylacetamide (DMAc) in a 1000 mL beaker. After 15 minutes, solid pyromellitic dianhydride (PMDA; 6.663 g) was added to the solution (0.99 mol/mol PMDA/PDA). The solution was stirred overnight at room temperature using a magnetic stir bar. At the end of the period the viscosity was measured using a rheometer.

Sample 16. Polyamic acid solution prepared at a total solids (PDA+PMDA) concentration in solvent=0.010 g/cm², and a PMDA-to-PDA mol ratio of 0.80 (Refer to FIG. 23). After stirring for 24 hours, 2.00 g of the polyamic acid solution of Sample 11 was diluted with 1.96 g of DMAc to give a final solution with a total solids concentration of 0.010 g/cm³. This new solution is referred to as Sample 16. The viscosity of the sol was immediately measured using a rheometer. No gels were prepared from Sample 16.

Sample 17. Polyamic acid solution prepared at a total solids (PDA+PMDA) concentration in solvent=0.010 g/cm³, and a PMDA-to-PDA mol ratio of 0 90 (Refer to FIG. 23). After stirring for 24 hours, 2.00 g of the polyamic acid solution of Sample 12 was diluted with 1.96 g of DMAc to give a final solution with a total solids concentration of 0.010 g/cm³. This new solution is referred to as Sample 17. The viscosity of the sol was immediately measured using a rheometer. No gels were prepared from Sample 17.

Sample 18. Polyamic acid solution prepared at a total solids (PDA+PMDA) concentration in solvent=0.010 g/cm³, and a PMDA-to-PDA mol ratio of 0.95 (Refer to FIG. 23). After stirring for 24 hours, 2.00 g of the polyamic acid solution of Sample 13 was diluted with 1.96 g of DMAc to give a final solution with a total solids concentration of 0.010 g/cm³. This new solution is referred to as Sample 18. The viscosity of the sol was immediately measured using a rheometer. No gels were prepared from Sample 18.

Sample 19. Polyamic acid solution prepared at a total solids (PDA+PMDA) concentration in solvent=0.010 g/cm³, and a PMDA-to-PDA mol ratio of 0.98 (Refer to FIG. 23). After stirring for 24 hours, 2,00 g of the polyamic acid solution of Sample 14 was diluted with 1.96 g of DMAc to give a final solution with a total solids concentration of 0.010 g/cm³. This new solution is referred to as Sample 19. The viscosity of the sol was immediately measured using a rheometer. No gels were prepared from Sample 19.

Sample 20. Polyamic acid solution prepared at a total solids (PDA+PMDA) concentration in solvent=0.010 g/cm³, and a PMDA-to-PDA mol ratio of 0.99 (Refer to FIG. 23). After stirring for 24 hours, 2.00 g of the polyamic acid solution of Sample 15 was diluted with 1.96 g of DMAc to give a final solution with a total solids concentration of 0.01 g/cm³. This new solution is referred to as Sample 20. The viscosity of the sol was immediately measured using a rheometer. No gels were prepared from Sample 20.

Sample 21. Polyamic acid solution and attempted preparation of polyimide aerogels at a total solids (PDA+PMDA) concentration in solvent=0,050 g/cm³, using a PMDA-to-PDA mol ratio of 0.99-Difference from Sample 9: the reaction mixture here was started by dissolving the dianhydride first (Refer to FIG. 23). Pyromellitic dianhydride (PMDA; 6.663 g) was dissolved in 200 mL of N,N-dimethylacetamide (DMAc) in a 500 mL beaker. After 30 minutes, solid 1,4-phenylenediamine (PDA; 3.337 g) was added to the solution (0.99 mol/mol PMDA/PDA). The solution was stirred overnight at room temperature using a magnetic stir bar. At the end of the period the viscosity was measured with a rheometer, and then 2.4 equivalent of pyridine (5.82 g, 5.93 ml) was added to the solution. After 2 minutes of mixing 4,3 equivalents of acetic anhydride (13.46 g, 12.46 mL) was added to the solution. The target density, T_{d}, of the resulting sol was 0.05 g/cm³. The new solution was divided into shallow circular aluminum casting dishes and was allowed to gel. The casting dishes were covered and were allowed to age for 24 hours. After the 24 hour aging period, the wet gels from Sample 21 were found to be extremely fragile and had already broken into pieces. The wet gel pieces could not be removed from the molds and were discarded. Since the resulting wet gels were not able to be transferred for supercritical fluid (SCF) carbon dioxide drying, no polyimide aerogel monoliths were produced from Sample 21.

### APPLICATIONS

One or more of the embodiments described above may be used in a variety of technological applications. Some embodiments may be used as: a ballistic barrier; a self-supporting, low density, high thermal insulation, hydrophobic housing, such as for wireless communication equipment (e.g., from 1 gigahertz (GHz) to 5 terahertz (THz) in the 5G and 6G communication frequencies); as thermal and structural insulation in airborne vehicles (planes, missiles, drones); thermal/moisture nosecone protection for airborne vehicles that is also transparent to communication frequencies; a substrate for a second phase disposed in pores of the aerogel, a mechanically strong and dimensionally stable plate that may or may not include a second phase (e.g., a battery cathode material or anode material); a mechanically strong and dimensionally stable carbonized plate that may or may not include a second phase (e.g., to form a collector-less rechargeable battery cathode and/or anode). Some embodiments may be used for a mechanically tough and/or high fracture toughness thermal insulation panel (e.g., having a thermal conductivity of less than 40 milliWatt/meter-Kelvin. In some examples, materials used in this context may also be processed to include or comprise a hydrophobe so that the mechanically tough insulating panel is hydrophobic.

### ASPECTS

To better illustrate the method and apparatuses disclosed herein, a non-limiting list of aspects is provided here:

Aspect 1. An aerogel composition comprising: a polyimide matrix comprised of linear polyimide molecules, the polyimide matrix having a nanoporous structure; wherein the linear polyimide molecules include a molecular weight greater than 10,000 g/mol; and the aerogel composition having a compressive yield stress greater than 1.5 MPa for a bulk density between 0.05 and 0.35 g/cm³.

Aspect 2. The aerogel composition of aspect 1, wherein the linear polyimide molecules include a molecular weight greater than 15,000 g/mol and less than 200,000 g/mol.

Aspect 3. The aerogel composition of aspect 1, wherein the aerogel composition includes a bulk density between 0.05 and 0.20 g/cm³.

Aspect 4. The aerogel composition of set,whereinth aerogel composition has a compressive yield stress greater than 1.5 MPa for a bulk density between 0.05 and 0.20 g/cm³.

Aspect 5. The aerogel composition of aspect 2, wherein the aerogel composition has a flexural strength greater than 0.4 MPa for a molecular weight greater than 10,000 g/mol.

Aspect 6. The aerogel composition of aspect 1, wherein the polyimide matrix includes a percent of crystallinity greater than zero.

Aspect 7. The aerogel composition of aspect 1, wherein the polyimide matrix includes a percent of crystallinity greater than 5%.

Aspect 8. The aerogel composition of aspect 1, wherein the polyimide matrix includes a percent of crystallinity between 5% and 10%.

Aspect 9. An aerogel composition comprising: a polyimide matrix comprised of linear polyimide molecules, the polyimide matrix having a nanoporous structure; wherein the linear polyimide molecules include a monomer length of N, where 30≤N≤650; and the aerogel composition having a density normalized compressive modulus greater than 13 J/g.

Aspect 10. The aerogel composition of aspect 9, wherein the linear polyimide molecules include a monomer length of N, where 50≤N≤400.

Aspect 11. The aerogel composition of aspect 9, wherein the aerogel composition includes a density normalized compressive modulus greater than 100 J/g.

Aspect 12. The aerogel composition of aspect 9, wherein the aerogel composition has a bulk density between 0.05 and 0.80 g/cm³.

Aspect 13. The aerogel composition of aspect 9, wherein the polyimide matrix includes a percent of crystallinity greater than zero.

Aspect 14. The aerogel composition of aspect 9, wherein the polyimide matrix includes a percent of crystallinity greater than 5%.

Aspect 15. The aerogel composition of aspect 9, wherein the polyimide matrix includes a percent of crystallinity between 5% and 60%.

Aspect 16. An aerogel composition comprising: a polyimide matrix comprised of linear polyimide molecules, the polyimide matrix having a nanoporous structure; wherein the linear polyimide molecules include a molecular weight greater than 10,000 g/mol; and the aerogel composition having a flexural strength greater than 0.4 MPa.

Aspect 17. The aerogel composition of aspect 16, wherein the aerogel composition has a bulk density between 0.05 and 0.80 g/cm³.

Aspect 18 The aerogel composition of aspect 16, wherein the polyimide matrix includes a percent of crystallinity greater than zero.

Aspect 19. A method of forming an aerogel composition, comprising: polymerizing dianhydride and diamine to form a linear molecule polyimide matrix with a molecular weight greater than 10,000 g/mol; gelling the linear molecule polyimide matrix without crosslinking to form a wet gel; and removing a solvent from the wet gel to form a polyimide aerogel.

Aspect 20. The method of aspect 19, wherein polymerizing dianhydride and diamine includes polymerizing PMDA and PDA.

Aspect 21. The method of aspect 19, wherein polymerizing dianhydride and diamine includes polymerizing a dianhydride chosen from BTDA, BPADA, BPDA, ODPA, DSDA, and 6FDA.

Aspect 22. The method of aspect 19, wherein polymerizing dianhydride and diamine includes polymerizing a diamine chosen from meta-PDA, ODA, BAPP, BDAF, DABP, DDM, DDS.

Aspect 23. The method of aspect 19, further including solubilizing the diamine in an amount of pyridine prior to polymerizing for a solution with a percent solid solution greater than 0.05 g/cm3.

Aspect 24. The method of aspect 19, further including annealing the wet gel at 68° C. before removing the solvent from the wet gel.

Aspect 25. The method of aspect 24, further including heat treating the polyimide aerogel at 300° C. for approximately 4 hours.

Aspect 26. The method of aspect 19, further including carbonizing the polyimide aerogel.

### CONCLUSION

Although an overview of the inventive subject matter has been described with reference to specific example embodiments, various modifications and changes may be made to these embodiments without departing from the broader scope of embodiments of the present disclosure, Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The foregoing description, for the purpose of explanation, has been described with reference to specific example embodiments. However, the illustrative discussions above are not intended to be exhaustive or to limit the possible example embodiments to the precise forms disclosed Many modifications and variations are possible in view of the above teachings. The example embodiments were chosen and described in order to best explain the principles involved and their practical applications, to thereby enable others skilled in the art to best utilize the various example embodiments with various modifications as are suited to the particular use contemplated.

It will also be understood that, although the terms “first,” “second,” and so forth may be used herein to describe various elements, these elements should not be limited by these terms. These terms are only used to distinguish one element from another. For example, a first contact could be termed a second contact, and, similarly, a second contact could be termed a first contact, without departing from the scope of the present example embodiments. The first contact and the second contact are both contacts, but they are not the same contact.

The terminology used in the description of the example embodiments herein is for the purpose of describing particular example embodiments only and is not intended to be limiting. As used in the description of the example embodiments and the appended examples, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if[a stated condition or event] is detected” may be construed to mean “upon determining” or “in response to determining” or “upon detecting [the stated condition or event]” or “in response to detecting [the stated condition or event],” depending on the context.

1-26. (canceled)

27. An aerogel composition comprising:
a polyimide matrix comprised of linear polyimide molecules, the polyimide matrix having a nanoporous structure,
wherein the polyimide matrix includes amorphous regions and crystalline regions,
wherein the linear polyimide molecules include a polymer chain length of N, where 30≤N≤650, and wherein the polymer chain length is defined by rheology using intrinsic viscosity, and
wherein the aerogel composition having a density normalized compressive modulus greater than 13 J/g, and wherein the density normalized compressive modulus is a compressive modulus of the aerogel composition normalized with respect to bulk density of the aerogel composition.

28. The aerogel composition of claim 27, wherein the polyimide matrix is prepared by dissolving a diamine in a solvent first followed by dissolving a dianhydride in the solvent.

29. The aerogel composition of claim 27, wherein the linear polyimide molecules include a polymer chain length of N, where 50≤N≤400.

30. The aerogel composition of claim 27, wherein the aerogel composition includes a density normalized compressive modulus greater than 100 J/g.

31. The aerogel composition of claim 27, wherein the aerogel composition has a bulk density between 0.05 and 0.80 g/cm³.

32. The aerogel composition of claim 27, wherein the polyimide matrix includes a percent of crystallinity greater than zero.

33. The aerogel composition of claim 27, wherein the polyimide matrix includes a percent of crystallinity greater than 5%.

34. The aerogel composition of claim 27, wherein the polyimide matrix includes a percent of crystallinity between 5% and 60%.

35. An aerogel composition comprising:
a polyimide matrix comprised of linear polyimide molecules, the polyimide matrix having a nanoporous structure;
the linear polyimide molecules being a reaction product of monomer dianhydride to monomer diamine at a stoichiometric ratio of 0.8 to 1.0, wherein the linear polyimide molecules include a molecular weight greater than 10,000 g/mol, and wherein the molecular weight is measured by rheology at 25° C. and at 1 rad/s; and
the aerogel composition having a compressive yield stress greater than 1.5 MPa for a bulk density between 0.05 and 0.35 g/cm³.

36. The aerogel composition of claim 35, wherein the linear polyimide molecules include a molecular weight greater than 15,000 g/mol and less than 200,000 g/mol.

37. The aerogel composition of claim 35, wherein the aerogel composition includes a bulk density between 0.05 and 0.20 g/cm³.

38. The aerogel composition of claim 35, wherein the aerogel composition has a compressive yield stress greater than 1.5 MPa for a bulk density between 0.05 and 0.20 g/cm³.

39. The aerogel composition of claim 35, wherein the aerogel composition has a flexural stress greater than 0.4 MPa for a molecular weight greater than 10,000 g/mol.

40. The aerogel composition of claim 35, wherein the polyimide matrix includes a percent of crystallinity greater than zero.

41. The aerogel composition of claim 35, wherein the polyimide matrix includes a percent of crystallinity greater than 5%.

42. The aerogel composition of claim 35, wherein the polyimide matrix includes a percent of crystallinity between 5% and 10%.

43. An aerogel composition comprising:
a polyimide matrix comprised of linear polyimide molecules, the polyimide matrix having a nanoporous structure,
wherein the polyimide matrix is prepared by dissolving a diamine in a solvent first followed by adding a dianhydride,
wherein the diamine is solubilized by pyridine for a solution with a percent solid solution greater than 0.05 g/cm³,
wherein the linear polyimide molecules include a molecular weight greater than 10,000 g/mol, and
wherein the aerogel composition has a flexural stress greater than 0.4 MPa.

44. The aerogel composition of claim 43, wherein the aerogel composition has a bulk density between 0.05 and 0.80 g/cm³.

45. The aerogel composition of claim 43, wherein the polyimide matrix includes a percent of crystallinity greater than zero.

46. A method of forming an aerogel composition, comprising:
polymerizing dianhydride and diamine to form a linear molecule polyimide matrix with a molecular weight greater than 10,000 g/mol, wherein a stoichiometry of the dianhydride and diamine is 0.8 to 1.0;
gelling the linear molecule polyimide matrix without crosslinking to form a wet gel; and
removing a solvent from the wet gel to form a polyimide aerogel.

47. The method of claim 46, wherein polymerizing dianhydride and diamine includes polymerizing PMDA and PDA.

48. The method of claim 46, wherein polymerizing dianhydride and diamine includes polymerizing a dianhydride chosen from BTDA, BPADA, BPDA, ODPA, DSDA, and 6FDA.

49. The method of claim 46, wherein polymerizing dianhydride and diamine includes polymerizing a diamine chosen from meta-PDA, ODA, BAPP, BDAF, DABP, DDM, DDS.

50. The method of claim 46, further including solubilizing the diamine in an amount of pyridine prior to polymerizing for a solution with a percent solid solution greater than 0.05 g/cm³.

51. The method of claim 46, further including annealing the wet gel at 68° C. before removing the solvent from the wet gel.

52. The method of claim 51, further including heat treating the polyimide aerogel at 300° C. for approximately 4 hours.

53. The method of claim 46, further including carbonizing the polyimide aerogel.
